(19) United States
(12) Patent Application Publication
(10) Pub. No.: US 2026/0205179 A1
(43) Pub. Date: Jul. 16, 2026

(54) VISUAL-BASED CHANNEL STATE INFORMATION (VCSI ) FOR ENHANCING RESOURCE ALLOCATION

(71) Applicant: QUALCOMM Incorporated, San Diego, CA (US)

(72) Inventors: Varun Amar REDDY, San Diego, CA (US); Alexandros MANOLAKOS, Athens (GR); Sony AKKARAKARAN, Poway, CA (US); Weimin DUAN, San Diego, CA (US); Bala RAMASAMY, San Marcos, CA (US)

(21) Appl. No.: 19/134,413

(22) PCT Filed: Oct. 30, 2023
(86) PCT No.: PCT/US2023/078206

§ 371 Date: May 30, 2025

(30) Foreign Application Priority Data
Dec. 22, 2022 (GR) 20220101070

(51) Int. Cl. H04B 7/06; H04W 64/00

(52) U.S. Cl. CPC H04B 7/0626; H04W 64/00

(57) ABSTRACT

In an aspect, a method of wireless communication performed by a user equipment (UE) is disclosed that includes obtaining a plurality of visual-based channel state information (vCSI) groups relating to an ambient environment of the UE; and determining an estimated position of the UE during a new radio (NR) positioning session based, at least in part, on at least one vCSI group of the plurality of vCSI groups.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below,

In an aspect, a method of wireless communication performed by a user equipment (UE) includes obtaining a plurality of visual-based channel state information (vCSI) groups relating to an ambient environment of the UE; and determining an estimated position of the UE during a new radio (NR) positioning session based, at least in part, on at least one vCSI group of the plurality of vCSI groups.

In an aspect, a method of wireless communication performed by a user equipment (UE) includes obtaining a plurality of visual-based channel state information (vCSI) groups relating to an ambient environment of the UE; and transmitting, to a further UE that has subsequently entered or is about to subsequently enter the ambient environment after the UE, an indication of one or more recommended vCSI groups for use by the further UE.

In an aspect, a user equipment (UE) includes a memory; at least one transceiver; and at least one processor communicatively coupled to the memory and the at least one transceiver, the at least one processor configured to: obtain a plurality of visual-based channel state information (vCSI) groups relating to an ambient environment of the UE; and determine an estimated position of the UE during a new radio (NR) positioning session based, at least in part, on at least one vCSI group of the plurality of vCSI groups.

In an aspect, a user equipment (UE) includes means for obtaining a plurality of visual-based channel state information (vCSI) groups relating to an ambient environment of the UE; and means for determining an estimated position of the UE during a new radio (NR) positioning session based, at least in part, on at least one vCSI group of the plurality of vCSI groups.

In an aspect, a user equipment (UE) includes means for obtaining a plurality of visual-based channel state information (vCSI) groups relating to an ambient environment of the UE; and means for transmitting, to a further UE that has subsequently entered or is about to subsequently enter the ambient environment after the UE, an indication of one or more recommended vCSI groups for use by the further UE.

In an aspect, a non-transitory computer-readable medium stores computer-executable instructions that, when executed by a user equipment (UE), cause the UE to: obtain a plurality of visual-based channel state information (vCSI) groups relating to an ambient environment of the UE; and determine an estimated position of the UE during a new radio (NR) positioning session based, at least in part, on at least one vCSI group of the plurality of vCSI groups.

In an aspect, a non-transitory computer-readable medium stores computer-executable instructions that, when executed by an UE, cause the UE to: obtain a plurality of visual-based channel state information (vCSI) groups relating to an ambient environment of the UE; and transmit, to a further UE that has subsequently entered or is about to subsequently enter the ambient environment after the UE, an indication of one or more recommended vCSI groups for use by the further UE.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 illustrates examples of various positioning methods supported in New Radio (NR), according to aspects of the disclosure.

FIG. 6 illustrates example Long-Term Evolution (LTE) positioning protocol (LPP) reference sources for positioning.

FIG. 7 illustrates an example Long-Term Evolution (LTE) positioning protocol (LPP) call flow between a UE and a location server for performing positioning operations.

FIG. 8 shows example communications between a UE and a base station that may be exchanged pursuant to generating and reporting visual-based channel state information (vCSI) based on captured visual data, according to aspects of the disclosure.

FIG. 9 shows example communications between a base station and a location server that may be exchanged pursuant to generating and reporting vCSI based on captured visual data, according to aspects of the disclosure.

FIG. 10 illustrates a positioning environment in which vCSI may be used to allocate resources used in determining the position of a UE, according to aspects of the disclosure.

FIG. 11 illustrates a positioning environment in which vCSI may be used to allocate resources used in determining the position of a UE, according to aspects of the disclosure.

FIG. 12 depicts a positioning environment in which communication resources between base stations and UEs may be mapped based on vCSI, according to aspects of the disclosure.

FIG. 13 illustrates an example method of wireless communication performed by a network node, according to aspects of the disclosure.

FIG. 14 illustrates an example method of wireless communication performed by a network node, according to aspects of the disclosure.

FIG. 15 illustrates an example method of wireless communication performed by a network node, according to aspects of the disclosure.

FIG. 16 illustrates an example method of wireless communication performed by a user equipment (UE), according to aspects of the disclosure.

FIG. 17 illustrates an example method of wireless communication performed by a user equipment (UE), according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station, Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs),

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

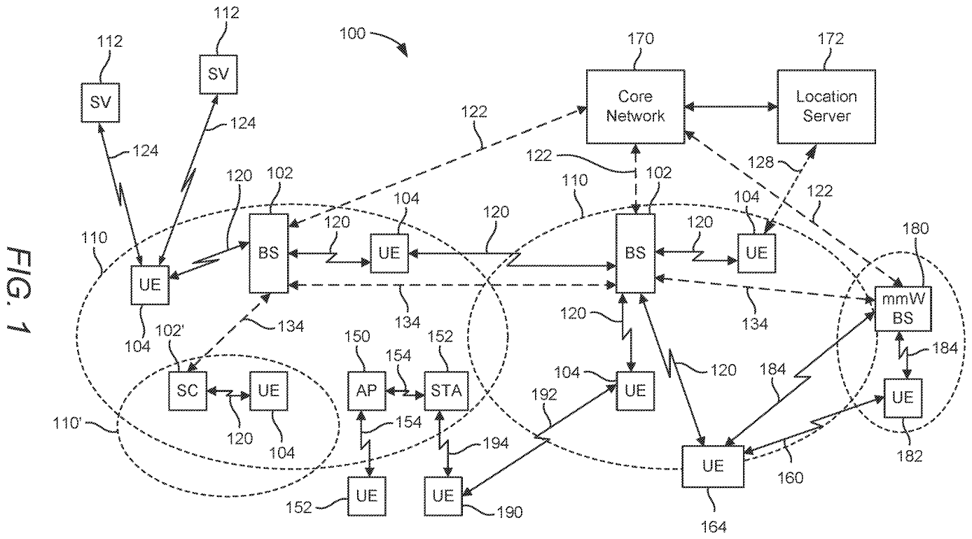

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS). subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCD), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity, The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′may employ LTE or NR technology and use the same 5 GHz unlicensed frequency spectrum as used by the WLAN AP 150. The small cell base station 102′. employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mm W) base station 180 that may operate in mm W frequencies and/or near mm W frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming. the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub- 6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mm W base station 180 may support one or more SCells for the UE 164.

In some cases, the UE 164 and the UE 182 may be capable of sidelink communication, Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based. at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth ®, and so on.

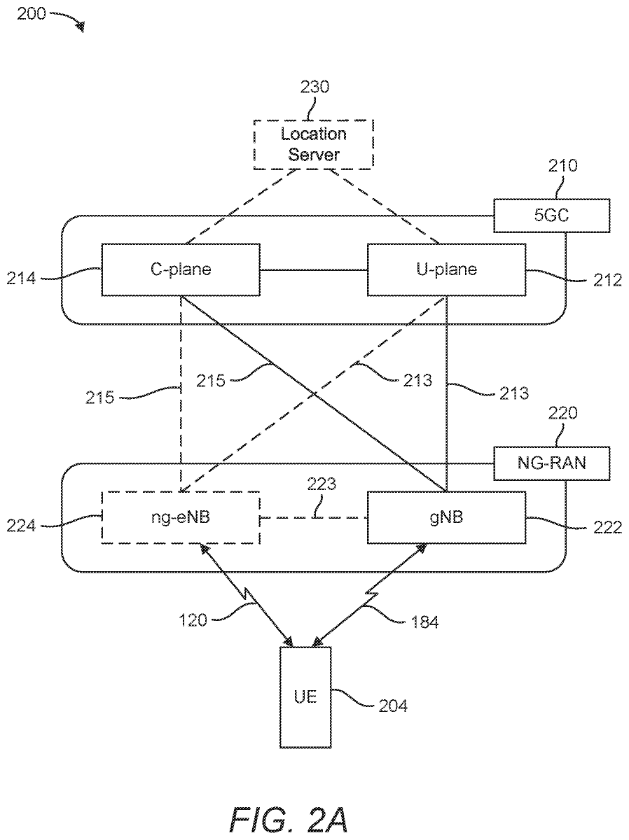

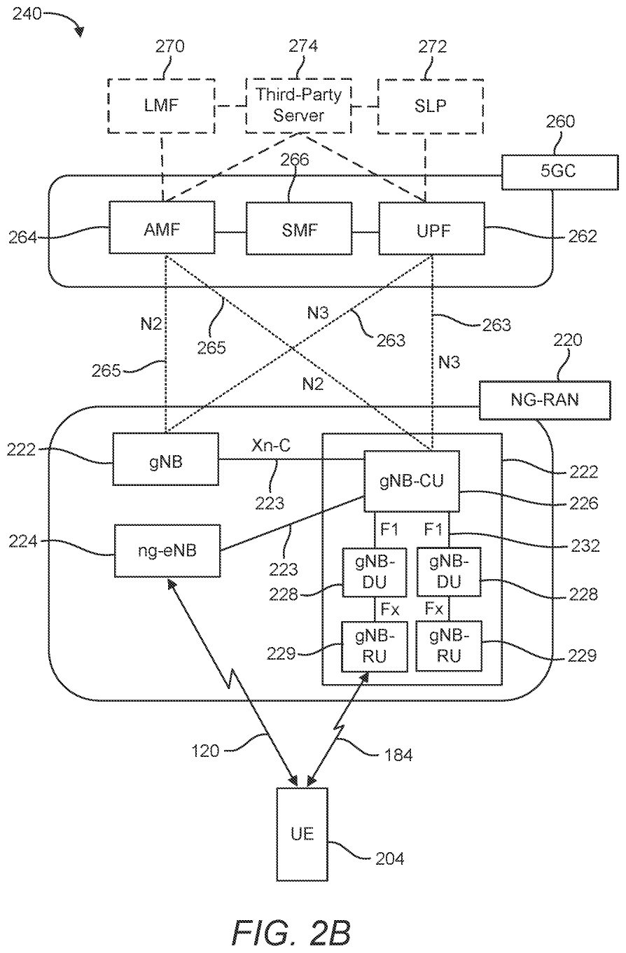

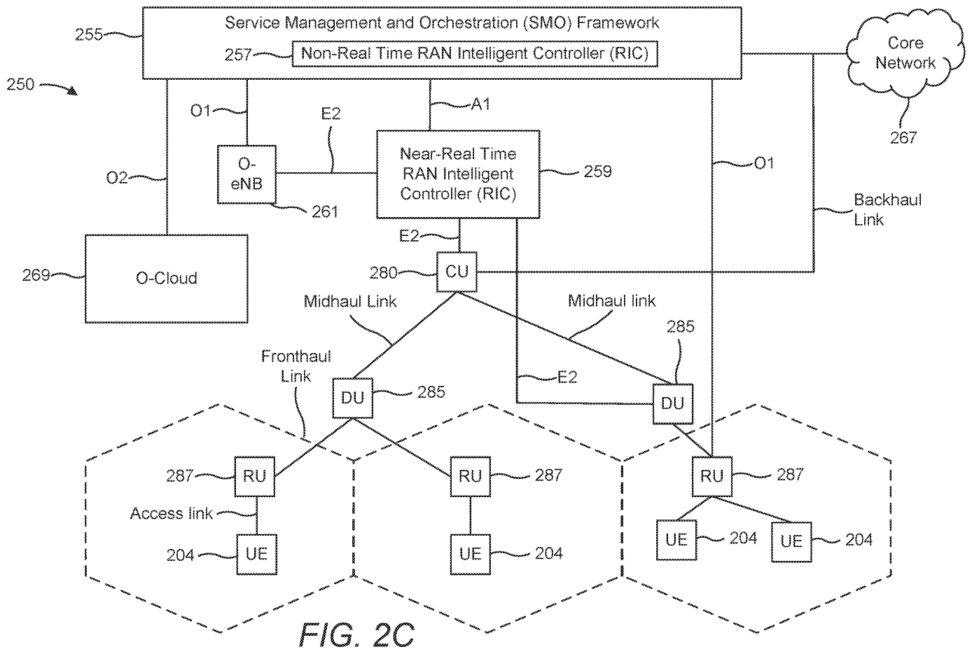

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240, A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF), The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the NII interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an Al interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

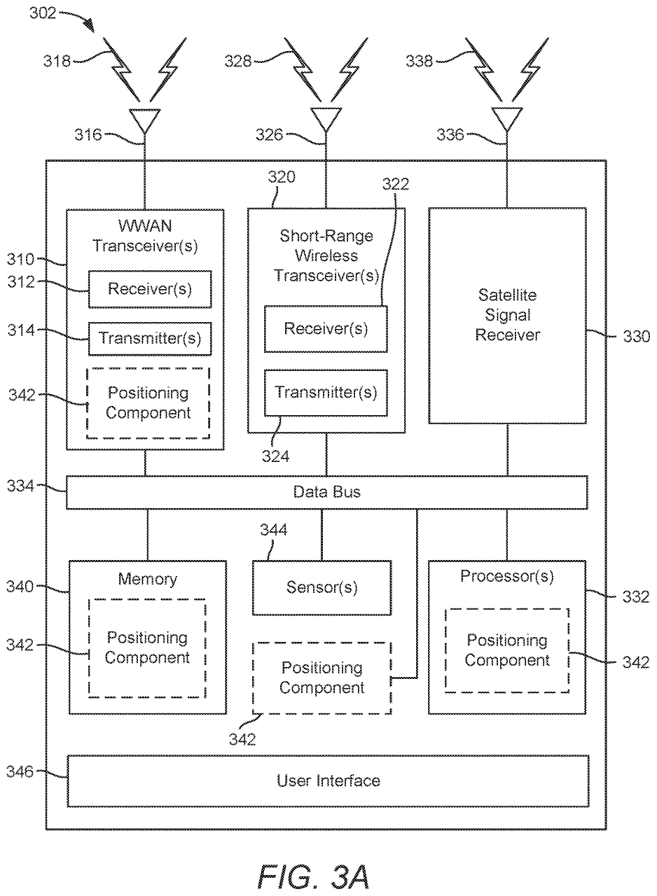

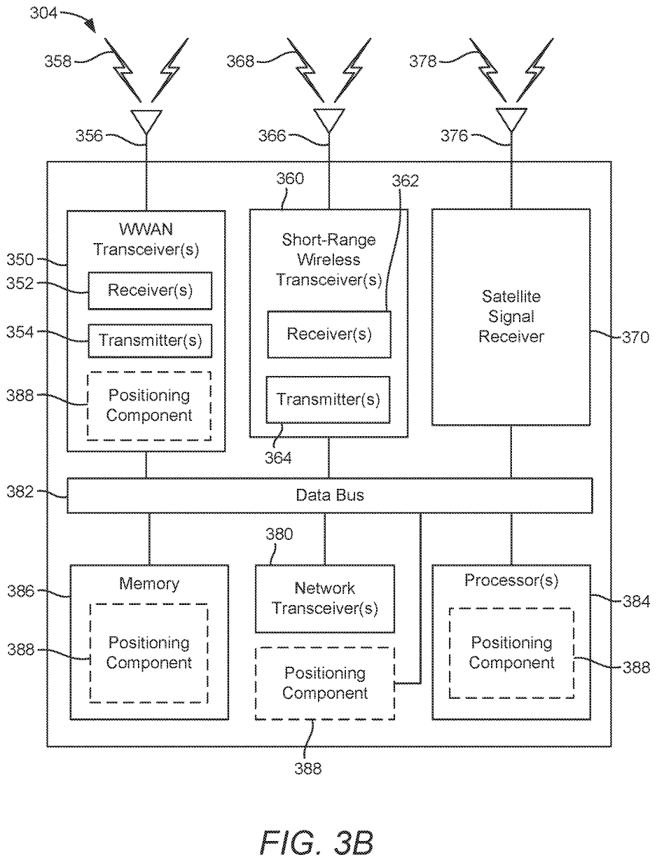

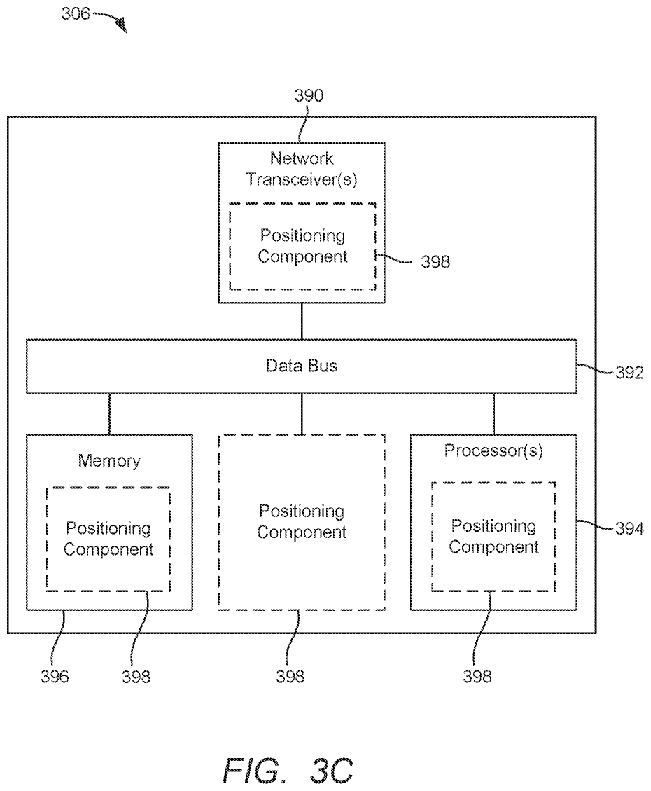

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein, In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

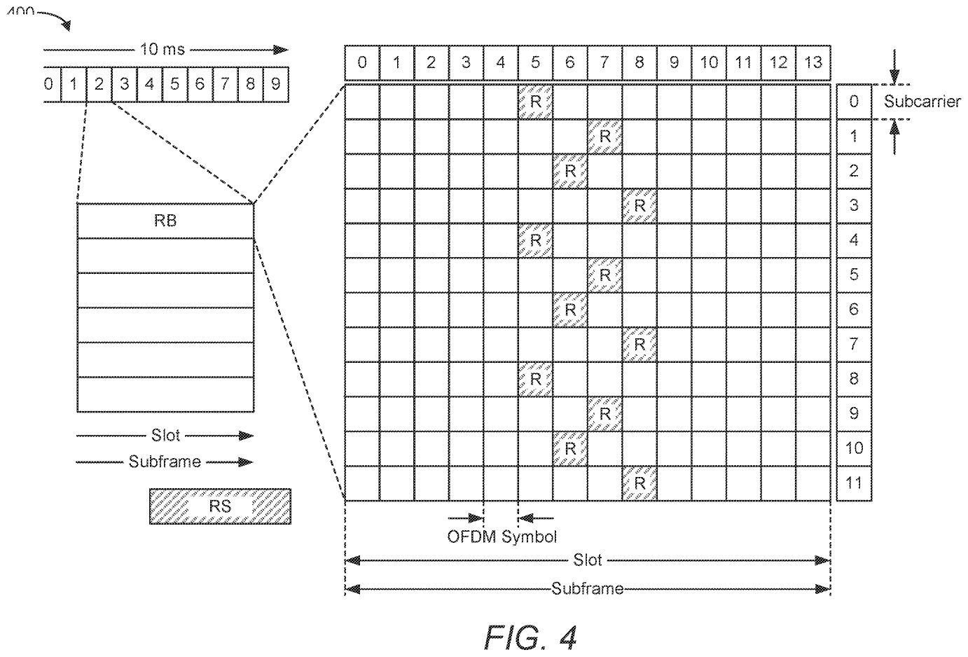

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi). Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS), The reference signals may include positioning reference signals (PRS), tracking reference signals (TRS), phase tracking reference signals (PTRS), cell-specific reference signals (CRS), channel state information reference signals (CSI-RS), demodulation reference signals (DMRS). primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 4); 12-symbol comb-4: {0,2, 1,3, 0, 2, 1, 3, 0, 2, 1, 3}; 6-symbol comb-6: {0, 3, 1, 4, 2, 5}; 12-symbol comb- 6: {0,3, 1, 4, 2, 5, 0, 3, 1, 4, 2, 5} ; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2 μ* {4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.” A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

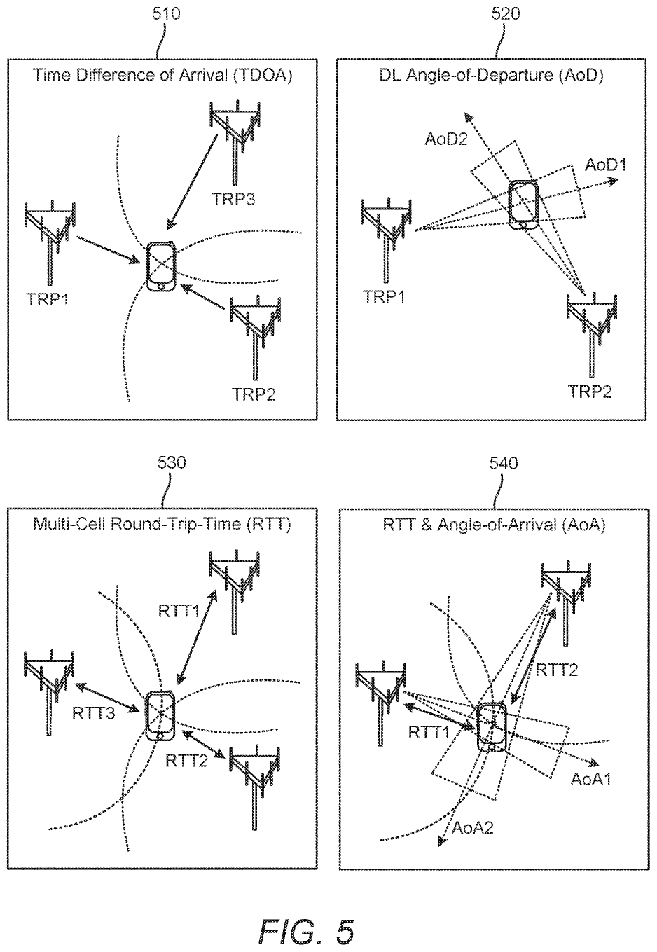

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 5 illustrates examples of various positioning methods, according to aspects of the disclosure. In an OTDOA or DL-TDOA positioning procedure, illustrated by scenario 510, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity, More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 520, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE, Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 530, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 540.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

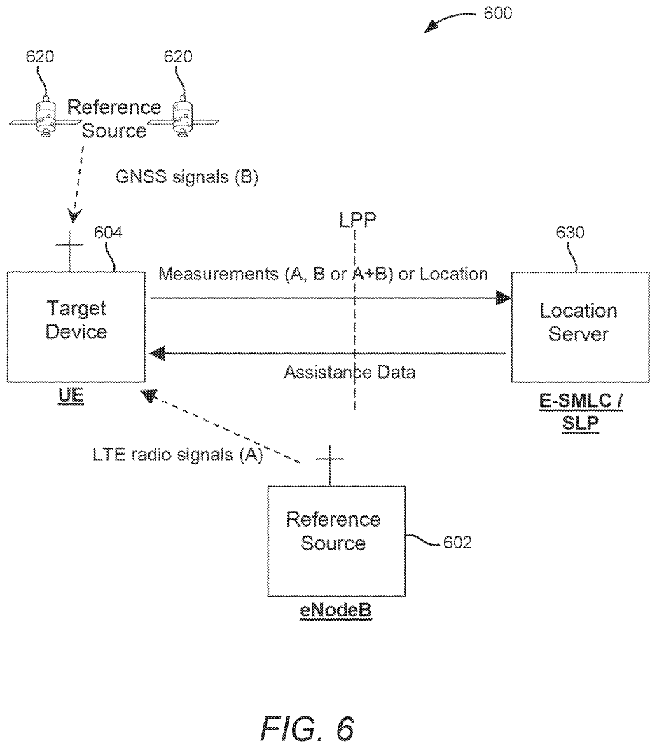

In LTE and, at least in some cases, NR, positioning measurements are reported through higher layer signaling, specifically, LTE positioning protocol (LPP) and/or RRC. LPP is used point-to-point between a location server (e.g., location server 230, LMF 270, SLP 272) and a UE (e.g., any of the UEs described herein) in order to position the UE using location related measurements obtained from one or more reference sources. FIG. 6 is a diagram 600 illustrating example LPP reference sources for positioning. In the example of FIG. 6, a target device, specifically a UE 604 (e.g., any of the UEs described herein), is engaged in an LPP session with a location server 630 (labeled as an “E-SMLC/SLP” in the specific example of FIG. 6). The UE 604 is also receiving/measuring wireless positioning signals from a first reference source, specifically one or more base stations 602 (which may correspond to any of the base stations described herein, and which is labelled as an “eNode B” in the specific example of FIG. 6), and a second reference source, specifically one or more SPS satellites 620 (which may correspond to SVs 112 in FIG. 1).

An LPP session is used between a location server 630 and a UE 604 in order to obtain location-related measurements or a location estimate or to transfer assistance data. A single LPP session is used to support a single location request (e.g., for a single mobile-terminated location request (MT-LR), mobile originated location request (MO-LR), or network induced location request (NI-LR)). Multiple LPP sessions can be used between the same endpoints to support multiple different location requests. Each LPP session comprises one or more LPP transactions, with each LPP transaction performing a single operation (e.g., capability exchange, assistance data transfer, location information transfer). LPP transactions are referred to as LPP procedures. The instigator of an LPP session instigates the first LPP transaction, but subsequent transactions may be instigated by either endpoint. LPP transactions within a session may occur serially or in parallel. LPP transactions are indicated at the LPP protocol level with a transaction identifier in order to associate messages with one another (e.g., request and response). Messages within a transaction are linked by a common transaction identifier.

LPP positioning methods and associated signaling content are defined in the 3GPP LPP standard (3GPP Technical Specification (TS) 36.355, which is publicly available and incorporated by reference herein in its entirety). LPP signaling can be used to request and report measurements related to the following positioning methods: observed time difference of arrival (OTDOA), downlink time difference of arrival (DL-TDOA), assisted global navigation satellite system (A-GNSS), LTE enhanced cell identity (E-CID), NR E-CID, sensor, terrestrial beacon system (TBS), WLAN, Bluetooth, downlink angle of departure (DL-AoD), uplink angle of arrival (UL-AoA), and multi-round-trip-time (RTT). Currently, LPP measurement reports may contain the following measurements: (1) one or more time of arrival (ToA), time difference of arrival (TDOA), reference signal time difference (RSTD), or reception-to-transmission (Rx-Tx) measurements, (2) one or more AoA and/or AoD measurements (currently only for a base station to report UL-AoA and DL-AoD to the location server 630), (3) one or more multipath measurements (per-path ToA, reference signal received power (RSRP), AoA/AoD), (4) one or more motion states (e.g., walking, driving, etc.) and trajectories (currently only for the UE 604), and (5) one or more report quality indications. In the present disclosure, positioning measurements, such as the example measurements just listed, and regardless of the positioning technology, may be referred to collectively as positioning state information (PSI).

The UE 604 and/or the location server 630 may derive location information from one or more reference sources, illustrated in the example of FIG. 6 as SPS satellite(s) 620 and the base station(s) 602. Each reference source can be used to calculate an independent estimate of the location of the UE 604 using associated positioning techniques. In the example of FIG. 6, the UE 604 is measuring characteristics (e.g., ToA, RSRP, RSTD, etc.) of positioning signals received from the base station(s) 602 to calculate, or to assist the location server 630 to calculate, an estimate of the location of the UE 604 using one or more cellular network-based positioning methods (e.g., multi-RTT, OTDOA, DL-TDOA, DL-AoD, E-CID, etc.). Similarly, the UE 604 is measuring characteristics (e.g., ToA) of GNSS signals received from the SPS satellites 620 to triangulate its location in two or three dimensions, depending on the number of SPS satellites 620 measured. In some cases, the UE 604 or the location server 630 may combine the location solutions derived from each of the different positioning techniques to improve the accuracy of the final location estimate.

As noted above, the UE 604 uses LPP to report location related measurements obtained from different of reference sources (e.g., base stations 602, Bluetooth beacons, SPS satellites 620, WLAN access points, motion sensors, etc.). As an example, for GNSS-based positioning, the UE 604 uses the LPP information element (IE) “A-GNSS-ProvideLocationInformation” to provide location measurements (e.g., pseudo ranges, location estimate, velocity, etc.) to the location server 630, together with time information. It may also be used to provide a GNSS positioning-specific error reason. The “A-GNSS-ProvideLocationInformation” IE includes IEs such as “GNSS-SignalMeasurementInformation,” “GNSS-LocationInformation,” “GNSS-MeasurementList,” and “GNSS-Error.” The UE 604 includes the “GNSS-LocationInformation” IE when it provides location and optionally velocity information derived using GNSS or hybrid GNSS and other measurements to the location server 630. The UE 604 uses the “GNSS-SignalMeasurementInformation” IE to provide GNSS signal measurement information to the location server 630 and the GNSS network time association if requested by the location server 630. This information includes the measurements of code phase, Doppler, C/No, and optionally accumulated carrier phase, also referred to as accumulated delta range (ADR), which enable the UE assisted GNSS method where location is computed in the location server 630. The UE 604 uses the “GNSS-MeasurementList” IE to provide measurements of code phase, Doppler, C/No, and optionally accumulated carrier phase (or ADR).

As another example, for motion sensor-based positioning, the currently supported positioning methods use a barometric pressure sensor and a motion sensor, as described in 3GPP TS 36.305 (which is publicly available and incorporated by reference herein in its entirety). The UE 604 uses the LPP IE “Sensor-ProvideLocationInformation” to provide location information for sensor-based methods to the location server 630. It may also be used to provide a sensor-specific error reason. The UE 604 uses the “Sensor-MeasurementInformation” IE to provide sensor measurements (e.g., barometric readings) to the location server 630. The UE 604 uses the “Sensor-MotionInformation” to provide movement information to the location server 630. The movement information may comprise an ordered series of points. This information may be obtained by the UE 604 using one or more motion sensors (e.g., accelerometers, barometers, magnetometers, etc.).

As yet another example, for Bluetooth-based positioning, the UE 604 uses the “BT-ProvideLocationInformation” IE to provide measurements of one or more Bluetooth beacons to the location server 630. This IE may also be used to provide Bluetooth positioning specific error reason.

Positioning determinations may be made in a UE assisted mode, a UE based mode, or a network based mode. In the UE assisted mode, the UE provides position measurements to a location server for computation of a location estimate by the location server. The network may provide assistance data to the UE to enable position measurements. In the UE based mode, the UE performs both position measurements and computation of a location estimate. Assistance data for one or both of these functions may be provided to the UE by the location server. In the network based mode, a serving public land mobile network (PLMN) obtains location measurements of signals transmitted by a UE and computes a location estimate. The transmission of the UE's signals for network based mode may or may not be transparent to the UE.

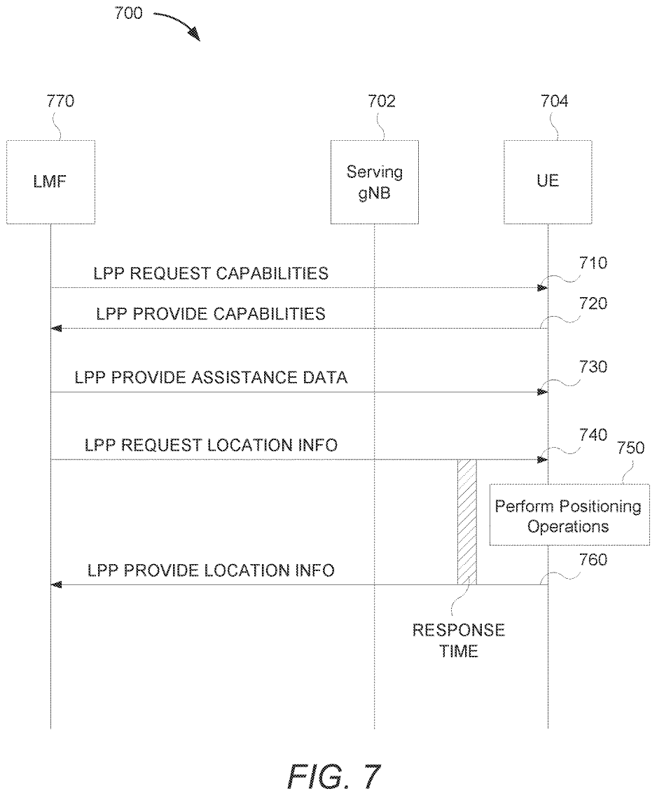

FIG. 7 illustrates an example Long-Term Evolution (LTE) positioning protocol (LPP) procedure 700 between a UE 704 and a location server (illustrated as a location management function (LMF) 770) for performing positioning operations. As illustrated in FIG. 7, positioning of the UE 704 is supported via an exchange of LPP messages between the UE 704 and the LMF 770. The LPP messages may be exchanged between UE 704 and the LMF 770 via the UE's 704 serving base station (illustrated as a serving gNB 702) and a core network (not shown). The LPP procedure 700 may be used to position the UE 704 in order to support various location-related services, such as navigation for UE 704 (or for the user of UE 704), or for routing, or for provision of an accurate location to a public safety answering point (PSAP) in association with an emergency call from UE 704 to a PSAP, or for some other reason. The LPP procedure 700 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 704 may receive a request for its positioning capabilities from the LMF 770 at stage 710 (e.g., an LPP Request Capabilities message). At stage 720, the UE 704 provides its positioning capabilities to the LMF 770 relative to the LPP protocol by sending an LPP Provide Capabilities message to LMF 770 indicating the position methods and features of these position methods that are supported by the UE 704 using LPP. The capabilities indicated in the LPP Provide Capabilities message may, in some aspects, indicate the type of positioning the UE 704 supports (e.g., DL-TDOA, RTT, E-CID, etc.) and may indicate the capabilities of the UE 704 to support those types of positioning.

Upon reception of the LPP Provide Capabilities message, at stage 720, the LMF 770 determines to use a particular type of positioning method (e.g., DL-TDOA, RTT, E-CID, etc.) based on the indicated type(s) of positioning the UE 704 supports and determines a set of one or more transmission-reception points (TRPs) from which the UE 704 is to measure downlink positioning reference signals or towards which the UE 704 is to transmit uplink positioning reference signals. At stage 730, the LMF 770 sends an LPP Provide Assistance Data message to the UE 704 identifying the set of TRPs.

In some implementations, the LPP Provide Assistance Data message at stage 730 may be sent by the LMF 770 to the UE 704 in response to an LPP Request Assistance Data message sent by the UE 704 to the LMF 770 (not shown in FIG. 7). An LPP Request Assistance Data message may include an identifier of the UE's 704 serving TRP and a request for the positioning reference signal (PRS) configuration of neighboring TRPs.

At stage 740, the LMF 770 sends a request for location information to the UE 704. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 730 may be sent after the LPP Request Location Information message at 740 if, for example, the UE 704 sends a request for assistance data to LMF 770 (e.g., in an LPP Request Assistance Data message, not shown in FIG. 7) after receiving the request for location information at stage 740.

At stage 750, the UE 704 utilizes the assistance information received at stage 730 and any additional data (e.g., a desired location accuracy or a maximum response time) received at stage 740 to perform positioning operations (e.g., measurements of DL-PRS. transmission of UL-PRS, etc.) for the selected positioning method.

At stage 760, the UE 704 may send an LPP Provide Location Information message to the LMF 770 conveying the results of any measurements that were obtained at stage 750 (e.g., time of arrival (ToA), reference signal time difference (RSTD), reception-to-transmission (Rx-Tx), etc.) and before or when any maximum response time has expired (e.g., a maximum response time provided by the LMF 770 at stage 740). The LPP Provide Location Information message at stage 760 may also include the time (or times) at which the positioning measurements were obtained and the identity of the TRP(s) from which the positioning measurements were obtained. Note that the time between the request for location information at 740 and the response at 760 is the “response time” and indicates the latency of the positioning session. The LMF 770 computes an estimated location of the UE 704 using the appropriate positioning techniques (e.g., DL-TDOA, RTT, E-CID, etc.) based, at least in part, on measurements received in the LPP Provide Location Information message at stage 760.

As discussed above, in UE based positioning modes, a UE may receive assistance data and determine its position estimate based, at least in part, on the resulting location measurements. For example, a location server (e.g., LMF) may configure the UE with PRS resources (e.g., PRS resource IDs) for measurements, provide location information for one or more base stations, provide satellite ephemeris data in the case of GPS or GNSS, and so on. In certain UE based positioning modes, the UE may make position related measurements without any positioning assistance data from a location server and may further compute a location or a change in location without any positioning assistance. The UE may report its position to the location server in a variety of manners. In an aspect, the UE may report its position periodically, non-periodically (e.g., when triggered by one or more events), or on-demand when requested by the location server or other network node.

Many UEs include imaging systems (e.g., image sensors, imaging devices, cameras, image storage, etc.) capable of capturing visual data (images and/or video). In accordance with certain aspects of the disclosure, such visual data may be used to determine characteristics of a UE's environment. In certain aspects, such visual data may be used for detecting and characterizing environments and objects captured in such visual data. In accordance with certain aspects of the disclosure, the captured visual data may be converted into visual-based channel state information, or vCSI, which may include characterizations (e.g., as indicated by labels or other annotations) of features and objects in the UE's environment. The vCSI may be reported by the UE to a base station (e.g., gNodeB) or a location server (e.g., LMF). Such vCSI may be standardized and communicated between network nodes of a 4G, 5G, and/or 6G radio system. Objects in the video data may be characterized as moving or nonmoving, human or nonhuman, etc. Similarly, the vCSI may characterize the environment as being indoors or outdoors. In certain aspects, the approximate size of indoor spaces may be estimated in the vCSI. In certain aspects, the vCSI may indicate directions associated with different objects and features. Still further, the vCSI may characterize objects, conditions, or features that as varying with time (e.g., mobile objects, weather conditions, etc.) and objects, conditions, or features that are generally constant over time (e.g., buildings, trees, other fixed structures, etc.). Further, the vCSI may identify features that are present throughout the environment (e.g., dense fog, heavy rain, etc.) as opposed to other weaker vCSI features that may no longer be present at a future time.

On UEs that do not have power or size restriction (e.g., a V2X device), the imaging system may operate in a low-power, always-on mode of operation. For UEs having power/battery constraints, the may UE may reduce operation of the imaging system to obtain vCSI opportunistically (e.g., before call or call handover). The UEs may also be in the form of devices that are dedicated to video surveillance or CSI sensing (e.g., imaging system mounted on a building wall, a streetlight, or a similar structure).

In accordance with aspects of the disclosure, base stations may also include imaging systems. In an aspect, each beam associated with the base station may be configured with a dedicated imaging system. Additionally, or in the alternative, each base station operated by the base station may be associated with one or more imaging systems. Additionally, or in the alternative, each antenna element group can be equipped with one or more imaging systems. Images and/or video captured at a base station antenna may be delivered to a distributed unit (DU) via a fronthaul link, where the DU abstracts vCSI from the captured images and/or video. It will be recognized, based on the teachings of the disclosure, that visual data from imaging systems operated by the base station and imaging systems operated at the UE may be combined to generate vCSI,

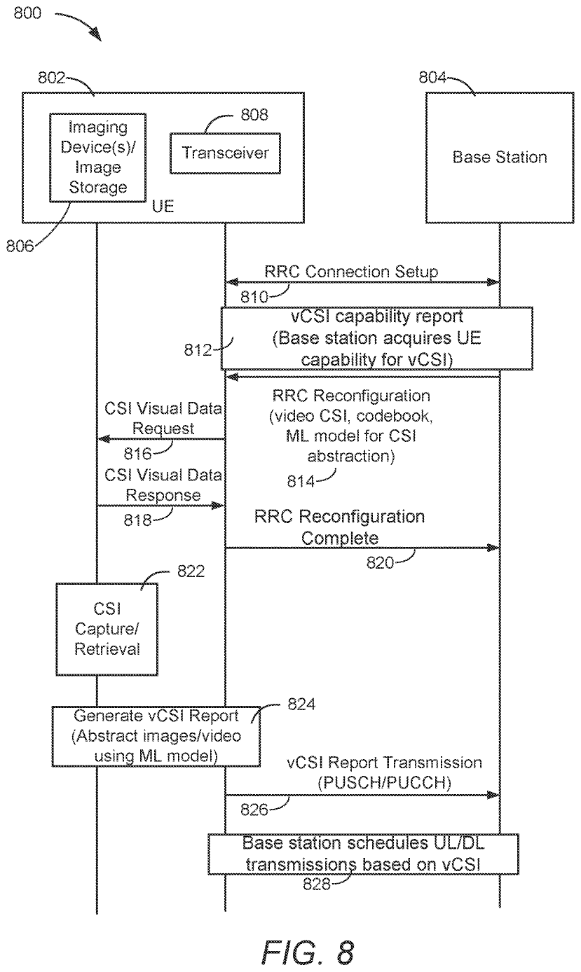

FIG. 8 shows example communications 800 between a UE 802 and a base station 804 that may be exchanged pursuant to generating and reporting vCSI based on captured visual data, according to aspects of the disclosure. The UE 802 may include an imaging system 806 that may include one or more imaging devices for capturing visual data (e.g., images and/or video) and image storage for storing the captured visual data. The UE 802 may also include a transceiver 808. Transceiver 808 may allow the UE 802 to communicate with base station 804 according to any suitable wireless communication protocol, such as a 4G, 5G, a WiFi communication protocol, an ultrawideband (UWB) communication protocol, etc. In an aspect, signaling between the transceiver 808 and the imaging system 806 may be based on modem interface commands.

The message exchange shown in FIG. 8 may be conducted in an RRC connection setup/configuration, during a positioning session in an LPP exchange, or a combination thereof. In this example, an RRC connection is established at operation 810. After or during the initial setup, the UE 802 may transmit a vCSI capability report 812 to the base station 804 indicating its capabilities for generating vCSI. The vCSI capability report 812 may indicate information such as the number of imaging devices available at the UE 802, the amount of image storage available at the UE 802, power or battery constraints of the UE 802 or the imaging system, the number of lenses available for CSI video/image acquisition, whether the UE supports base station direction tracking, and/or whether the UE supports on-demand direction tuning. In accordance with certain aspects of the disclosure, the vCSI capability report 812 may indicate directions, elevation ranges, azimuth ranges, etc., over which the imaging devices may be operated to capture images and/or video.

After reporting the vCSI capabilities, the UE 802 may receive reconfiguration information via one or more RRC reconfiguration messages 814. Such reconfiguration information may include configuration information for generating the vCSI, such as a codebook associated with the vCSI, one or more machine learning (ML) models used by the UE 802 for generating the vCSI based on captured visual data, an identification of one or more ML models pre-configured at the UE 802 for generating the vCSI, etc. In accordance with certain aspects of the disclosure, the RRC reconfiguration messages 814 may indicate parameters to be used by the UE 802 for an initial scan of the environment of the UE 802 for storage in the image storage of the imaging system 806. It will be recognized, based on the teachings of the present disclosure, that various combinations of such RRC reconfiguration information, as well as additional types of configuration information, may be included in the RRC reconfiguration message 814.

In accordance with certain aspects of the disclosure, the base station 804 may submit a vCSI request in the RRC reconfiguration message 814 to the UE 802 to generate a vCSI report. Additionally, or in the alternative, the vCSI request may be submitted as a separate message in an LPP exchange.

In an aspect, the vCSI request may include an indication of the direction, range of elevation, range of azimuth, and/or focal range of visual images and/or video that are to be captured for generating the vCSI by the imaging system 806. In an aspect, the UE 802 may store visual images and/or video in a direction, over an elevation range, over an azimuth range, over a focal range, or a combination thereof, prior to receiving the vCSI request. In an aspect, the vCSI request may include an indication of the direction, elevation range, azimuth range, and/or focal range of visual images and/or video that is to be retrieved from image storage of the imaging system 806 for generating the vCSI. In various aspects, the vCSI request may be submitted to the base station 804 on a periodic basis, asynchronously, in response to triggering events, etc.

In response to the vCSI request, the UE 802 may submit a CSI visual data request 816 that the imaging system 806 acquire or retrieve the visual data indicated in the vCSI request. The imaging system 806 may return a CSI visual data response 818 indicating that the imaging system 806 has been configured to obtain the visual data indicated, for example, in the vCSI request. In turn, the UE 802 may indicate that the RRC reconfiguration 814 has been completed by returning an RRC reconfiguration complete message 820 to the base station.

The imaging system 806 may capture or retrieve the visual data indicated by the vCSI request for generating the vCSI at operation 822 and use the captured/retrieved visual data to generate the vCSI report at operation 824 according to the parameters indicated in the RRC reconfiguration message 814 (using a codebook, an ML model, etc.). The generated vCSI may be compressed or abstracted, for example, according to the parameters indicated in the RRC reconfiguration message 814. In accordance with certain aspects, the vCSI may include tagged objects and/or conditions indicating environmental fixtures and conditions existing between the UE 802 and the base station 804. The compressed or abstracted vCSI may be transmitted at operation 826 to the base station 804, for example, via the physical uplink shared channel (PUSCH) or the physical uplink control channel (PUCCH).

In accordance with certain aspects of the disclosure, the base station 804 may send the vCSI report transmitted to the base station 804 may be used by the base station 804 to schedule UL and DL transmissions at operation 828. In accordance with certain aspects of the disclosure, information in the vCSI report may be sent to a location server associated with the base station 804 (not shown in FIG. 8 for simplicity) for scheduling positioning resources. In an aspect, the UE 802 may provide the vCSI report to the location server via LPP messaging.

In accordance with certain aspects of the disclosure, the UE 802 may send visual data generated by the imaging system 806 to the base station 804 (or a location server associated with the base station 804), where it is processed to generate the vCSI report. Such operations may be useful if the UE 802 does not have the processing capability to generate the vCSI report on its own.

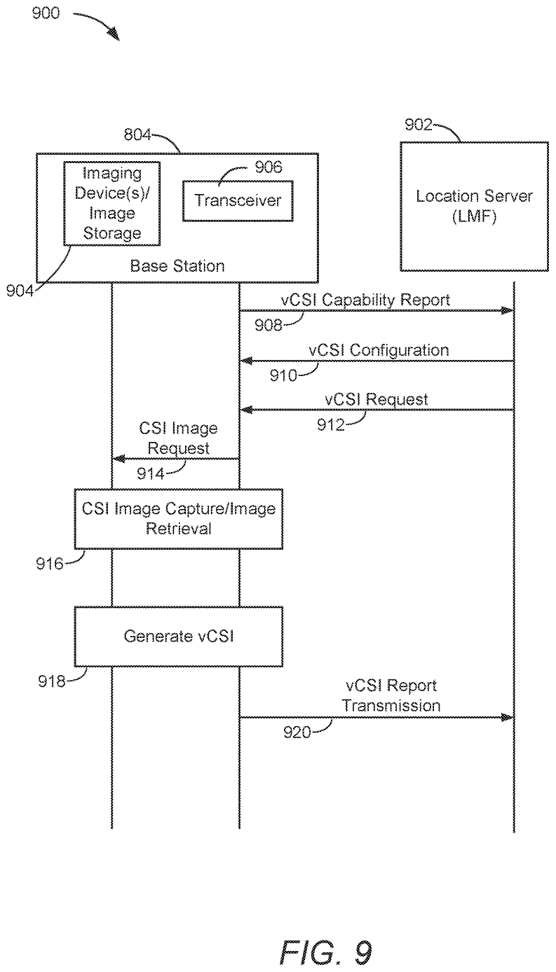

FIG. 9 shows example communications 900 between a base station 804 and a location server 902 that may be exchanged pursuant to generating and reporting vCSI based on captured visual data, according to aspects of the disclosure. In an aspect, signaling between the base station 804 and location server 902 may use the New Radio positioning protocol type A (NRPPa).

In accordance with certain aspects of the disclosure, the base station 804 may be associated with one or more imaging systems 904. In accordance with certain aspects of the disclosure, the imaging systems 904 may be co-located with the base station 804, co-located with one or more TRPs of the base station 804, or a combination thereof. When one or more base stations are configured with imaging systems, the base station 804 may communicate with the imaging systems 904 at each of the base stations. In accordance with aspects of the disclosure, each of the imaging systems 904 may include at least one or more imaging devices for capturing visual data such as images and/or video and image storage for storing the captured visual data. Additionally, the base station 804 may include a transceiver 906. The transceiver 906 may allow the base station 804 to communicate with the location server 902 according to any suitable wireless communication protocol, such as a 4G, 5G, a WiFi communication protocol, an ultrawideband (UWB) communication protocol, etc.

After or during an initial setup, the base station 804 may transmit a vCSI capability report 908 to the location server 902 indicating its capabilities for generating vCSI. The vCSI capability report 908 may indicate information such as the number of base stations having imaging systems 904, the locations of the base stations having imaging systems 904, a number of imaging devices available at the base station 804 and/or at each TRP, the amount of image storage available at the base station 804 and/or at each TRP, the ability of the imaging system 904 to visually track one or more UEs, etc. In accordance with certain aspects of the disclosure, the vCSI capability report 908 may also indicate directions, elevation ranges, azimuth ranges, etc., over which the imaging systems 904 may be operated to capture images and/or video.

After reporting the vCSI capabilities, the base station 804 may receive vCSI configuration information 910 from the base station 804 to configure the imaging systems 904 based on the reported vCSI capabilities. Such vCSI configuration information in 910 may include configuration information for generating the vCSI, such as a codebook associated with the vCSI, one or more machine learning (ML) models to be used by the base station 804 for generating the vCSI based on captured visual data, an identification of one or more ML models pre-configured at the base station 804 for generating the vCSI, etc. In accordance with certain aspects of the disclosure, the vCSI configuration information 910 may indicate parameters to be used by the base station 804 for an initial scan of the environments of the base station and/or TRPs for storage in the image storage of the imaging systems 904. It will be recognized, based on the teachings of the present disclosure, that various combinations of such vCSI configuration information, as well as additional types of configuration information, may be included in the vCSI configuration information 910.

In accordance with certain aspects of the disclosure, the location server 902 may submit a vCSI request 912 to the base station 804 to generate a vCSI report. In an aspect, the vCSI request in 1912 may include an indication of the direction, range of elevation, range of azimuth, and/or focal range of visual images and/or video that are to be captured for generating the vCSI and one or more of the imaging systems 904. In an aspect, the base station 804 and/or TRPs may store visual images and/or video in specified directions, over elevation ranges, over azimuth ranges, over focal ranges, or a combination thereof, prior to receiving the vCSI request 912. In an aspect, the vCSI request 912 may include an indication of the directions, elevation ranges, azimuth ranges, and/or focal ranges of visual images and/or video that is to be retrieved from image storage of the one or more of the imaging systems 904. In various aspects, the vCSI request 912 may be submitted to the base station 804 on a periodic basis, asynchronously, in response to a triggering event, etc.

In response to the vCSI request 912, the base station 804 may request that the imaging systems 904 acquire or retrieve the visual data indicated in the vCSI request 912. In an aspect, this request may be in the form of CSI image requests 914 that is submitted to the imaging systems 904. In certain aspects, the transceiver 906 may facilitate communication between the base station 804 and the imaging systems 904 located at the TRPs of the base station 804. In tum, the imaging systems 904 may capture or retrieve the visual data indicated by the CSI image request 914 for generating the vCSI The base station 804 may engage in CSI image capture and/or image retrieval operations 916 and use the captured/retrieved image information to generate the vCSI report at operation 918 according to the parameters indicated in the vCSI configuration information 910 (using a codebook, an ML model, etc.). In accordance with certain aspects of the disclosure, the vCSI report may also be based on visual data and/or vCSI reports from one or more UEs serviced by the base station 804.

In certain aspects, the positioning operations configured by the location server may be based, at least in part, on vCSI. In an aspect, vCSI may be used to allocate resources that are optimized for positioning a UE based on vCSI associated with the environment that exists between the UE and one or more base stations. In an aspect, a network node (e.g., location server, base station, sidelink UE, etc.) may obtain vCSI relating to a UE that is to be positioned and a plurality of base stations. Based on the vCSI, the network node may determine which of the plurality of base stations will be configured for determining the position of the UE.

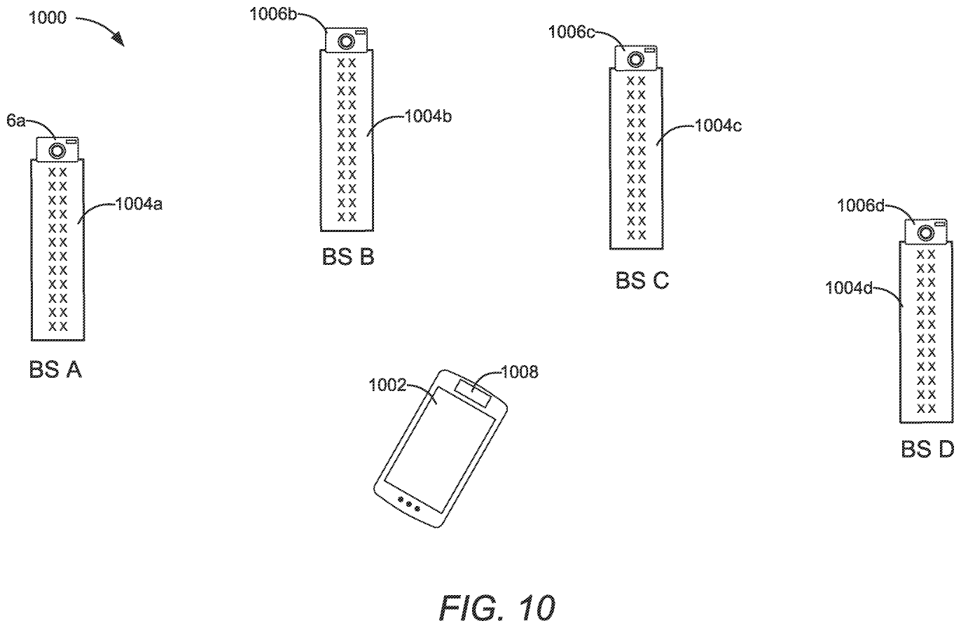

FIG. 10 illustrates a positioning environment 1000 in which vCSI may be used to allocate resources used in determining the position of a UE 1002, according to aspects of the disclosure. In the example shown in FIG. 10, the positioning environment 1000 includes a plurality of base stations, labeled BS A through BS D, each having a corresponding set of one or more antenna panels 1004a through 1004d. Further, each of BS A through BS D includes one or more imaging systems 1006a through 1006d. The imaging systems 1006a through 1006d may be co-located with the base stations, BS A through BS B. In certain aspects, one or more of the base stations, BS A through BS D, may include one or more antenna sub-panels, each having a corresponding imaging system 1006 oriented, for example, along a boresight of the corresponding antenna sub-panel to acquire visual images and/or video in the direction of the antenna sub-panel. Additionally, the UE 1002 may include an imaging system 1008 for obtaining images and/or video of the UE's environment. In accordance with aspects of the disclosure, the imaging system 1008 of the UE 1004 and/or imaging systems 1006a through 1006d of the base stations be used to acquire images and/or video of the environment existing between each of the base stations, BS A through BS D, and the UE 1002, from which vCSI may be generated to characterize the positioning environment. The base stations, BS A through BS D, may be associated with the same base station or with different base stations that are served by the same location server (e.g., LMF).

In accordance with certain aspects of the disclosure, the vCSI may be used to determine a subset of base stations that will be used in a positioning session in which an estimate of the position of the UE 1002 is obtained. This subset of base stations may be selected to obtain optimized positioning performance for positioning the UE 1002 in the positioning environment 1000. In an aspect, the set of base stations may be selected based on a geometric dilution of precision (GDOP) relationship between the UE 1002 and the plurality of base stations, BS A through BS D, as determined from the vCSI Additionally, or in the alternative, the set of base stations may be selected based on line-of-sight (LOS) conditions between the base stations, BS A through BS D, and the UE 1002 as determined from the vCSI. Additionally, or in the alternative, the set of base stations may be selected based on maintaining 1) a GDOP condition, 2) LOS conditions, or 3) a combination thereof between the set of base stations and the UE as the UE moves in the positioning environment 1000.

The vCSI and/or visual data used to generate the vCSI may be obtained from a number of different sources. In this regard, the vCSI and/or visual data used to determine the vCSI may be obtained from 1) the UE 1002, 2) another UE in the same region as the UE 1002 (e.g., another UE associated with the same cell ID as UE 1002), 3) one or more base stations associated with the plurality of base stations, BS A through BS D, or 4) any combination thereof.

In an aspect, at least a portion of the vCSI may be obtained from the UE, which may indicate an orientation of an imaging system and/or image sensor of the UE used to obtain the portion of the vCSI at the UE. When such information is available, the set of base stations may be selected based on the orientations of antenna beams of the base stations with respect to the indicated orientation of the imaging system and/or image sensor of the UE as determined from the vCSI.

In accordance with certain aspects of the disclosure, the vCSI is obtained from other network nodes (e.g., base stations, UEs, etc.) by a location server (e.g., LMF). In an aspect, the location server may obtain the vCSI and select which of the base stations will be used during the positioning session. In turn, the location server may transmit assistance data to the UE 1002 indicating the set of base stations that the UE is to use for the positioning session. The assistance data may also indicate a priority is assigned to the base stations of the set. The indicated priorities may be used, for example, to determine the order in which the base stations are measured by the UE 1002 (e.g., the order in which RS transmitted by the set of base stations are measured).

In accordance with certain aspects of the disclosure, the vCSI may provide directionality and orientation information. For example, the UE 1002, through the vCSI, can indicate, to a network node (e.g., base station, location server, etc.), the intended directionality of an upcoming reference signal (e.g., UL SRS) transmission. In turn, the network node may determine a set of antenna beams of the UE 1002 that the UE 1002 is to use for transmitting the upcoming uplink RS. The determination of the set of antenna beams may be based on the directionality of the upcoming uplink RS as determined from the vCSI. In an aspect, the network node may transmit assistance data to the UE 1002, including an indication of the set of antenna beams of the UE 1002 that the UE 1002 is to use for transmitting the upcoming uplink RS. In an aspect, the assistance data may indicate a prioritization of the set of antenna beams of the UE for transmitting the upcoming uplink RS. Selecting the antenna beams of the UE 1002 in this manner may optimize antenna beam scanning procedures by limiting the number of antenna beams scanned in the antenna beam scanning procedures to a subset of the available antenna beams (e.g., the limited number of beams swept constituting a reduced search space).

This approach to reducing the antenna beam search space may also be applied to downlink RS (e.g., DL PRS). In such instances, the vCSI may provide the directionality of antenna beams that the base stations will use to transmit downlink RS. Given a frame of reference, the directionality of a beam represents the azimuth and elevation angle of the corresponding beam. More generally, the directionality of a beam can be represented by certain values in a three-dimensional spherical coordinate system. Additionally, the orientation of the UE with respect to the base stations, optionally, may also be indicated by or determined from the vCSI. In an aspect, the network node (e.g., location server) may select the base stations that have antenna beams directed toward the UE, as indicated by or determined from the vCSI, as the subset of base stations that are to be used in the positioning session. In an aspect, the base stations transmitting downlink RS using antenna beams that are generally aligned with the UE provide higher positioning accuracy. In an aspect, the set of base stations may be prioritized based on the alignment and indicated in assistance data transmitted to the UE.

In accordance with certain aspects of the disclosure, one or more base stations, BS A through BS D, may include a single antenna panel or one or more sub-panels of antennas. In such instances, the network node may determine the set of base stations that are to be used for positioning based on the orientation of the panels/sub-panels of antennas (e.g., the orientation of the boresight of the antenna panel/sub-panel) with respect to the orientation of the imaging system (e.g., the orientation of the axis of the image sensor used to obtain the visual information) of the UE as determined from the vCSI. To this end, panels/sub-panels of antennas of base stations having an orientation that generally aligns or otherwise intersects at a threshold angle with the axis of orientation of the imaging system are more likely to provide better positioning performance than sub-panels of antennas of base stations that are skewed or otherwise not aligned with the orientation of the imaging system. In an aspect, the set of base stations may be prioritized based on the orientation of their corresponding sub-panels, where sub-panels having orientations that are more aligned with the orientation of the imaging sensor of the UE are given a higher priority. In an aspect, the UE may receive assistance data indicating the set of base stations and, optionally, the corresponding antenna sub-panels that are to be measured during the positioning session (e.g., the order in which RS transmitted by the set of base stations and/or corresponding antenna sub-panels are measured). In instances in which the base station only includes a single antenna panel, the orientation of the single panel with respect to the orientation of the imaging system may be used in determining whether the base station is included in the set of base stations that are to be measured by the UE.

The network node may obtain information regarding the orientation of the panels/sub-panels of antennas in various manners. In an aspect, the orientation of the sub-panels may be determined from the vCSI. Additionally, or in the alternative, the orientation of the panels/sub-panels may be based on base station almanac information associated with the plurality of base stations.

In accordance with certain aspects of the disclosure, the network node may provide the vCSI to one or more UEs. In various aspects, the network node may provide the vCSI in a point-to-point manner or through broadcast transmissions. In an aspect, the vCSI may be included in assistance data transmitted to the UEs. Additionally, or in the alternative, the network node may include the vCSI in unicast and/or groupcast data transmitted by the network node. Additionally, or in the alternative, the network node may transmit the vCSI in a SIB, such as a positioning SIB (posSIB).

In accordance with certain aspects of the disclosure, the network node may identify a network location from which the one or more UEs may obtain the vCSI. Additionally, or in the alternative, the network node may indicate vCSI identifiers, which can be used to obtain the corresponding vCSI from a pre-configured network location. The network location and/or vCSI identifiers from which the vCSI may be obtained may be provided in assistance data, unicast data, groupcast data, a SIB, or a combination thereof. Such aspects of the disclosure may be used to reduce the amount of data traffic used by the network node to provide the vCSI to the UEs.

In accordance with certain aspects of the disclosure, the vCSI may indicate the expected positioning uncertainty associated with using the vCSI. In an aspect, the vCSI uncertainty may be related to directionality and/or positioning uncertainty associated with using various base stations in the area for positioning. In an aspect, the vCSI data may indicate a first set of uncertainties associated with distance and/or direction if the vCSI is used without base stations, and a second set of uncertainties if used jointly with the base stations.

In accordance with the various aspects of the disclosure, the network node may group vCSI based on achieving a particular accuracy for directionality and/or ranging. In an example, a first group of vCSI (e.g. group 1) may be indicated for use if a 1 degree accuracy in two-dimensional positioning is to be achieved. A second group or group combination (e.g., group 1+group 2) may be indicated for use to achieve 1 degree accuracy in three-dimensional positioning. A third group or group combination (e.g., group 1+group 2+group 3) may be indicated for use to achieve 0.5 degree accuracy in three-dimensional positioning.

In accordance with certain aspects of the disclosure, the network node may obtain the vCSI from all the network devices (e.g., UEs and/or base stations) within a defined environment (e.g., crowdsource all nearby vCSI data) and associate the vCSI data with the base stations in the defined environment. In accordance with aspects of the disclosure, the network node may also prioritize the vCSI data. In an aspect, general prioritization rules may be applied. Additionally, or in the alternative, the network node may prioritize the vCSI based on such factors as the weather conditions, the time of day, the day of the week, the day of the month, the month of the year, etc. Additionally, or in the alternative, the network node may prioritize the vCSI data based on feedback from UEs in the positioning environment. In certain aspects, the network node only transmits or otherwise identifies vCSI meeting specified prioritization criterion.

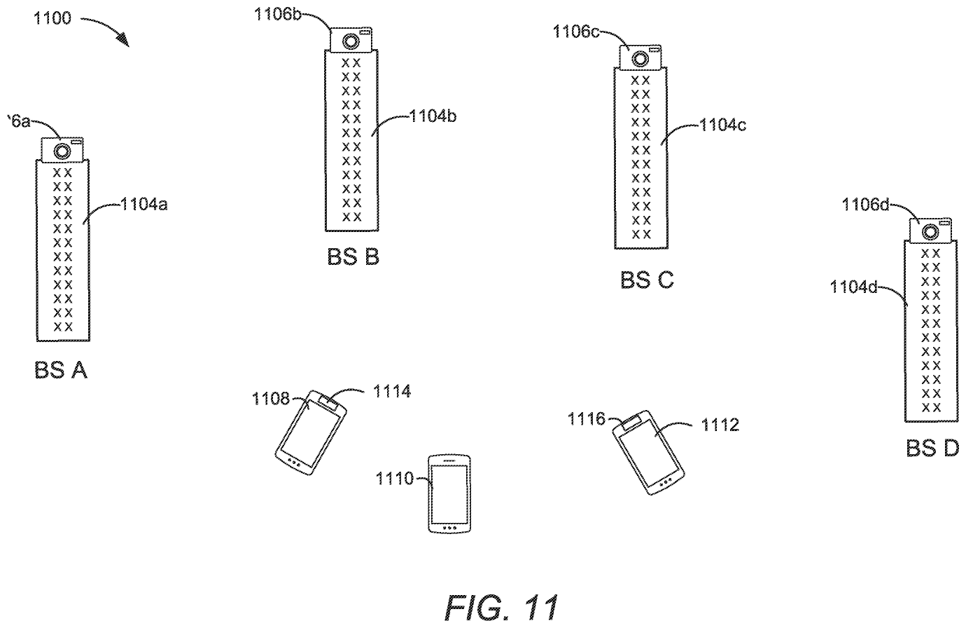

FIG. 11 illustrates a positioning environment 1100 in which vCSI may be used to allocate resources used in determining the position of a UE, according to aspects of the disclosure. In the example shown in FIG. 11, the positioning environment 1100 includes a plurality of base stations, labeled BS A through BS D, each having a corresponding set of one or more antenna panels 1104a through 1104d. Further, each of BS A through BS D includes one or more imaging systems 1106a through 1106d. The imaging systems 1106a through 1106d may be co-located with the base stations, BS A through BS B. In certain aspects, one or more of the base stations, BS A through BS D, may include one or more antenna sub-panels, each having a corresponding imaging system 1106 oriented, for example, along a boresight of the corresponding antenna sub-panel to acquire visual images and/or video in the direction of the antenna sub-panel.

In FIG. 11, the positioning environment 1100 includes three UEs 1108, 1110, and 1112. Both UE 1108 and UE 1112 include respective imaging systems 1114 and 1116. The UE 1110, however, is not configured with an imaging system. The imaging system 1114 may be used to obtain images and/or videos of the environment of the UE 1108. The images and/or video of the environment of the UE 1108 may be used to generate vCSI for UE 1108. In an aspect, the UE 1108 may generate the vCSI based on the images and/or video it obtains. The vCSI for the UE 1108 may then be transmitted to a network node (e.g., location server) and used in a positioning session to determine the position of the UE 1108. Additionally, or in the alternative, the UE 1108 may transmit its images and/or video to the network node, where the images and/or video are used to generate the vCSI for UE 1108 and used in allocating positioning resources during a positioning session to determine the position of the UE 1108. Similarly, the imaging system 1116 may be used to obtain images and/or videos of the environment of the UE 1112. The images and/or video of the environment of the UE 1112 may be used to generate vCSI for UE 1112. In an aspect, the UE 1112 may generate the vCSI based on the images and/or video it obtains. The vCSI for the UE 1112 may be transmitted to a network node (e.g., location server) for use in a positioning session to determine the position of the UE 1112. Additionally, or in the alternative, the UE 1112 may transmit its images and/or video to the network node, where the images and/or video are used to generate the vCSI for UE 1112 and used in a positioning session to determine the position of the UE 1112.

In accordance with certain aspects of the disclosure, a network node (e.g., location server, LMF, etc.) may provide a UE with vCSI for other UEs in the same positioning area. In the example positioning environment 1100 shown in FIG. 11, the UEs 1108, 1110, and 1112 are in the same positioning area. In an aspect, the determination that the UEs are in the same positioning area may be based on their association with the same serving cell ID. However, other manners of determining that the UEs 1108, 1110, and 1112 are in the same positioning area may be employed in accordance with certain aspects of the disclosure.

Since the UEs 1108 and 1112 are in the same positioning area, the vCSI for UE 1108 may be relevant to determining the position of UE 1112. Similarly, the vCSI for UE 1112 may be relevant to determining the position of UE 1112. In accordance with certain aspects of the disclosure, therefore, the vCSI for UE 1108 may be shared with (e.g., transmitted to) the UE 1112 for use in a positioning session in which the position of the UE 1112 is determined. In an aspect, the vCSI for UE 1108 may be provided to UE 1112 as assistance data from a location server. Additionally, or in the alternative, the vCSI for UE 1112 may be shared with (e.g., transmitted to) the UE 1108 for use in a positioning session in which the position of the UE 1108 is determined. In an aspect, the vCSI for UE 1112 may be provided to UE 1108 as assistance data from a location server.

As noted, UE 1110 does not have an imaging system in the example positioning environment 1100 shown in FIG. 11. Nevertheless, in accordance with certain aspects of the disclosure, the location server may provide the UE 1110 with vCSI for UE 1108 and/or vCSI for the UE 1112. In this manner, even UEs without imaging systems may benefit from receiving vCSI associated with other UEs in the same positioning area.

Certain aspects of the disclosure are implemented with an understanding that the complete set of the vCSI for a given UE may not be relevant to determining the position of another UE in the same positioning area. For example, the complete set of the vCSI for the given UE may be substantially omnidirectional in that it includes vCSI for substantially all directions within the environment with respect to the given UE. However, certain aspects of the disclosure recognize that only a subset of vCSI of the given UE that is filtered for a particular direction may be relevant to the positioning of another UE in the same positioning area. Accordingly, in accordance with certain aspects of the disclosure, the vCSI for the given UE provided to other UEs in the same positioning area may be a filtered version of the complete set vCSI that is otherwise available for the given UE (or which otherwise might be generated for the given UE). In this manner, communication overhead may be reduced since only the subset of the vCSI data (as opposed to the complete set of vCSI data) that is relevant to another UE and the same positioning area is transmitted to the other UE for positioning.

A filtered version of the complete set of vCSI for a given UE may be obtained and used in different manners. In an aspect, a location server may request a subset of the entire vCSI that is filtered with respect to a given direction as indicated to the given UE by the location server. In such instances, the filtered subset of the vCSI may be transmitted by the given UE to the location server and subsequently provided to other UEs in the same positioning area as assistance data. In another aspect, the location server may obtain the complete set of vCSI from the given UE and filter the complete set of vCSI to provide a filtered subset of vCSI for the given direction. Again, the filtered subset of vCSI may be transmitted by the location server to another UE in the same positioning area as assistance data so that only vCSI relevant to determining the position of the other UE is transmitted to the other UE. In another aspect, the location server may request that the given UE generate vCSI with respect to a given direction, even though the given UE is capable of generating vCSI for other directions. As such, the vCSI generated by the given UE may be considered a filtered subset of the larger set of vCSI that may otherwise be generated at the given UE.

In accordance with certain aspects of the disclosure, communication resources between UEs and the base stations may be allocated based on the vCSI. In an aspect, a location server (e.g., LMF) may request vCSI reports from one or more base stations (e.g., gNBs) and multiple UEs within the positioning environment. Based on GDOP conditions, LOS conditions, or a combination thereof, a mapping or grouping between the base station/TRPs and the UEs may be determined to improve resource utilization.

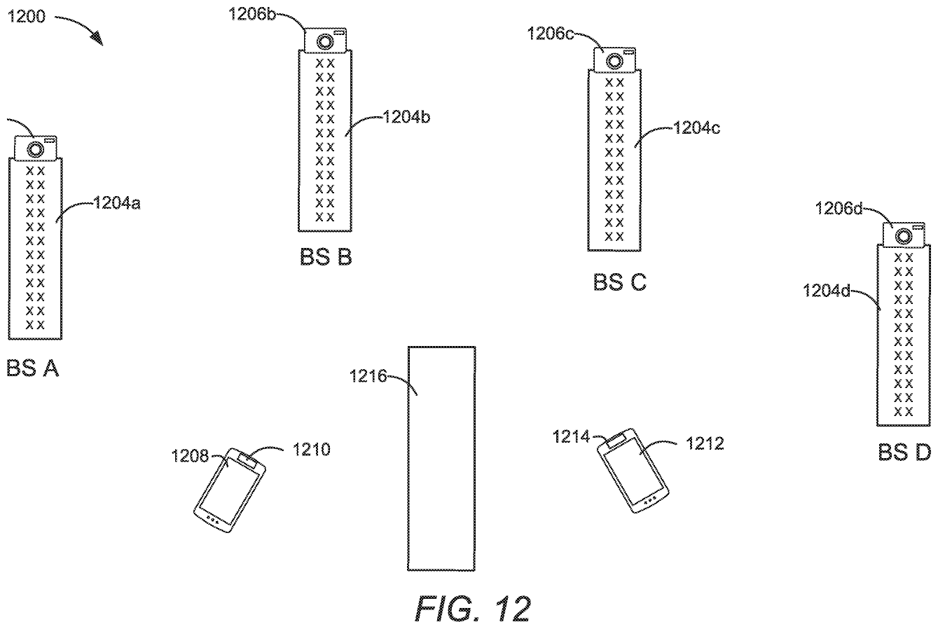

FIG. 12 depicts a positioning environment 1200 in which communication resources between base stations and UEs may be mapped based on vCSI, according to aspects of the disclosure. In the example shown in FIG. 12, the positioning environment 1200 includes a plurality of base stations, labeled BS A through BS D, each having a corresponding set of one or more antenna panels 1204a through 1204d. Further, each of BS A through BS D includes one or more imaging systems 1206a through 1206d. The imaging systems 1206a through 1206d may be co-located with the base stations, BS A through BS B. In certain aspects, one or more of the base stations, BS A through BS D, may include one or more antenna sub-panels, each having a corresponding imaging system 1206 oriented, for example, along a boresight of the corresponding antenna sub-panel to acquire visual images and/or video in the direction of the boresight of the antenna sub-panel.

The positioning environment 1200 further includes a UE 1208 having an imaging system 1210 and a UE 1212 having an imaging system 1214. The UEs 1208 and 1212 are separated from one another by an object 1216. Based on vCSI for the positioning environment 1200 obtained from base stations and/or UEs in the positioning environment 1200, the location server may determine that object 1216 blocks lines of sight between UE 1208 and BS C and BS D. However, the vCSI may indicate that LOS paths exist between UE 1208 and BS A and BS B. As such, the location server maps BS A and/or BS B to UE 1208. Similarly, the location server may determine, based on the vCSI for the positioning environment 1200 that object 1216 blocks lines of sight between UE 1212 and BS A and BS B. However, the vCSI may indicate that LOS paths exist between UE 1212 and BS C and BS D. As such, the location server maps BS C and/or BS D to UE 1212. In an aspect, the location server may map the communication resources so that BS A and BS B communicate with UE 1208 using the same time-frequency resources as used by BS C and BS D in communications with UE 1212. In accordance with certain aspects of the disclosure, the mapping may specify directionality information to allow the location server to improve spatial reuse of the resources and reduce interference at UEs (on DL communications) and at the base stations/TRPs (on UL communications).

In accordance with certain aspects of the disclosure, training methodologies may be employed at the base stations based on the vCSI. To this end, the location server may create a “visual map” of the environment using objects and features identified in the vCSI with respect to a given base station around the vicinity of a given UE. Such vCSI reporting may include exchanges of messages between the UEs, base stations, and the location server for the positioning environment. In an example, a “visual map” may be constructed at a given TRP based on previous vCSI that it has received as part of a training process based on previous vCSI measurements. The visual map may be used to assist a UE (e.g., currently in the positioning environment or new to the positioning environment) to subsequently obtain vCSI in the environment for comparison with the visual map. As an example, the UE may capture some vCSI in its vicinity (including the object 1216), which would be compared with the visual map. The current and/or new UEs may be guided as to how they can communicate with one another based on the visual map. For instance, with reference to FIG. 12, UE 1208 could transmit at different points of the object 1216 (identified via vCSI) to determine how to position/communicate with other devices in the positioning environment 1200, such as UE 1212.

In accordance with certain aspects of the disclosure, UEs can also exchange vCSI information directly with one another via sidelink communications. In out-of-coverage scenarios, a relay node or an ad-hoc ‘hub’ may be present (in place of the location server) that facilitates the exchange of vCSI information among a group of SL UEs.

Certain aspects of the disclosure are directed to the formation and use of vCSI groups, both from a network server perspective and a UE perspective. In accordance with an aspect, a UE may obtain a plurality of vCSI groups relating to an ambient environment of the UE. The position of the UE may be determined during an NR positioning session based, at least in part, on at least one vCSI group of the plurality of vCSI groups.

Different vCSI groups of the plurality of the vCSI groups may groups based on their different characteristics. In an aspect, the vCSI groups may be grouped according to the types of visual features included in each vCSI group. Certain vCSI groups may be grouped based on the types of visual features included in the groups. As an example, multiple vCSI groups may be associated with the same field of view but have different visual features. The visual features included in a vCSI group may be based on the visibility of various visual features in the same field of view under different ambient environmental conditions. Various ambient environmental conditions may contribute to the visibility of the visual features within a vCSI group. For example, visual features may have different levels of visibility based on different weather conditions, different lighting conditions, different times of day, etc. Some visual features (e.g., large buildings, large signage, large trees, and other large objects) within the field of view may be visible in low light conditions (e.g., at night) or low-visibility weather conditions (e.g., rain, snow, fog, etc.) while other visual features (e.g., lane markers, small vegetation, etc.) are not as visible under the same conditions. Similarly, certain visual features may be more persistent in the environment than other visual features. In such instances, vCSI groups may be grouped based on those visual features meeting a threshold degree of visibility under a given set of ambient environmental conditions. As such, one vCSI group may include only visual features visible under low-visibility ambient environmental conditions, while another vCSI group may include all visual features visible under high-visibility ambient environmental conditions. In an aspect, certain vCSI groups may include visual features that are visible in clear weather and/or good lighting conditions while other vCSI groups may include only those visual features that are likely to be visible in foggy conditions, at nighttime, etc. Certain vCSI groups may include an indication as to the ambient environmental conditions under which the vCSI group is most likely valuable for determining the position of the UE.

In an aspect, the vCSI groups may be grouped according to the number of visual features included in each vCSI group and/or the positioning resolution obtainable using each vCSI group. In an aspect, a vCSI group having a larger number of visual features may result in the ability of the UE to resolve its angular orientation and/or directionality with a higher degree of accuracy (e.g., higher resolution, lower uncertainty, etc.) than another vCSI group having the same field of view but with fewer visual features. Similarly, a vCSI group having certain types of visual features may result in the ability of the UE to resolve its angular orientation and/or directionality with a higher degree of accuracy than another vCSI group having the same field of view but with a different set of visual features. Additionally, or in the alternative, certain vCSI groups may be grouped according to the angular resolution and/or angular measurement uncertainty that is obtainable by the UE for its angular position, directionality, and/or orientation using the vCSI group. In such instances, the vCSI groups may include an indication of the angular resolution and/or angular measurement uncertainty that is obtainable by the UE using the vCSI group.

Other criteria may be used to form the vCSI groups, For example, the plurality of vCSI groups may be grouped based on a directionality of the UE with respect to one or more base stations. Additionally, or in the alternative, the plurality of vCSI groups may be grouped based on the orientations of antenna beams of one or more base stations with respect to the UE. The plurality of vCSI groups additionally, or alternatively, may be grouped based on the signal strengths of reference signals received by the UE from antenna beams of one or more base stations. In each such instance, it will be recognized that the vCSI groups may include the same, different, and/or overlapping fields of view. The vCSI groups may be based, at least in part, on an orientation in a global reference frame or in a relative reference frame. Still further, the vCSI groups may be based, at least in part, on a correspondence with one or more NR Signals (e.g. SSB, PRS, etc). Such groupings may also be in a global or relative reference frame. It will be recognized, based on the teachings of the present disclosure, that other features and/or characteristics of the vCSI may be used as grouping criteria to form the vCSI groups, all of the foregoing groupings constituting non-limiting examples.

The plurality of vCSI groups may be obtained by the UE in various manners. For example, the UE may receive information indicating the plurality of vCSI groups from a network server. In an aspect, the UE may obtain the data for the vCSI groups or an indication as to where the UE may retrieve the data for the vCSI groups (e.g., a network location at which the vCSI groups are stored) from the network server in assistance data and/or in system information block (SIB) transmissions (e.g., in one or more positioning SIBs (posSIBs).

Additionally, or in the alternative, the UE may receive a set of vCSI from the network server and determine the plurality of vCSI groups based on the set of vCSI using various grouping criteria. Again, the set of vCSI may be included or indicated in assistance data and/or SIBs. Once the UE has formed the vCSI groups, the UE may transmit the vCSI groups to a network server, a sidelink UE, or a combination thereof.

In accordance with certain aspects of the disclosure, the UE may acquire vCSI and form the vCSI groups autonomously. To this end, the UE may acquire image data of the UE's ambient environment (e.g., using an integrated UE camera, imaging devices in communication with the UE (e.g., smart glasses, vehicle-mounted imaging devices), etc.). The UE may then generate the plurality of vCSI groups at the UE based on the image data. In various scenarios, the UE may transmit the plurality of vCSI groups that it generates to a network server.

The vCSI groups may be used in an NR positioning session to obtain an estimate of the position of the UE. To this end, one or more range measurements for the position estimate may be obtained based, at least in part, on measurements of resource signals (RS) (e.g., SRS and/or PRS) transmitted between the UE and one or more transmission-reception points (TRPs). In an aspect, the range measurements may be based on TOA, TDOA, and/or OTDOA measurements.

Additionally, the position estimate may be based on one or more angle measurements (e.g., directionality, the angular orientation of the UE with respect to one or more base stations/visual features, etc.). Such angle measurements may be based, at least in part, on visual features and/or characteristics of one or more of the vCSI groups. In accordance with certain aspects of the disclosure, the angle measurements may be relative to an orientation of an image sensor associated with the UE with respect to one or more vCSI groups. Additionally, or in the alternative, the UE may determine an angular resolution of the one or more angle measurements based on the one or more vCSI groups and/or an angular measurement uncertainty based on the one or more vCSI groups. In an aspect, the visual features of two or more vCSI groups may be combined to obtain a desired angular resolution and/or angle measurement uncertainty.

The UE may obtain angular measurements (e.g., AoA, etc.) using the NR positioning techniques. In such instances, the angle measurements obtained using the vCSI groups may be used to enhance the accuracy of the NR angle measurements, validate the NR angle measurements, or be used as an alternative to the NR angle measurements.

In accordance with certain aspects of the disclosure, the knowledge of a UE as to the utility of certain vCSI groups in an ambient environment may be leveraged to assist another UE that has recently entered or is about to enter the ambient environment. In an aspect, the UE obtains a plurality of vCSI groups relating to an ambient environment of the UE. The UE may develop a set of recommended vCSI groups based on its experience with the vCSI groups within the ambient environment. For example, the recommended vCSI groups may be based, at least in part, on 1) the visibility of visual features in one or more vCSI groups as determined at the UE, 2) position measurements (e.g., the positioning accuracy) obtained by the UE based on the one or more vCSI groups, 3) angular resolutions obtained by the UE based on the one or more vCSI groups, or 4) any combination thereof.

Once the UE has formed a set of recommended vCSI groups, the UE may transmit, to a further UE that has subsequently entered or is about to subsequently enter the ambient environment after the UE, an indication of one or more recommended vCSI groups for use by the further UE.

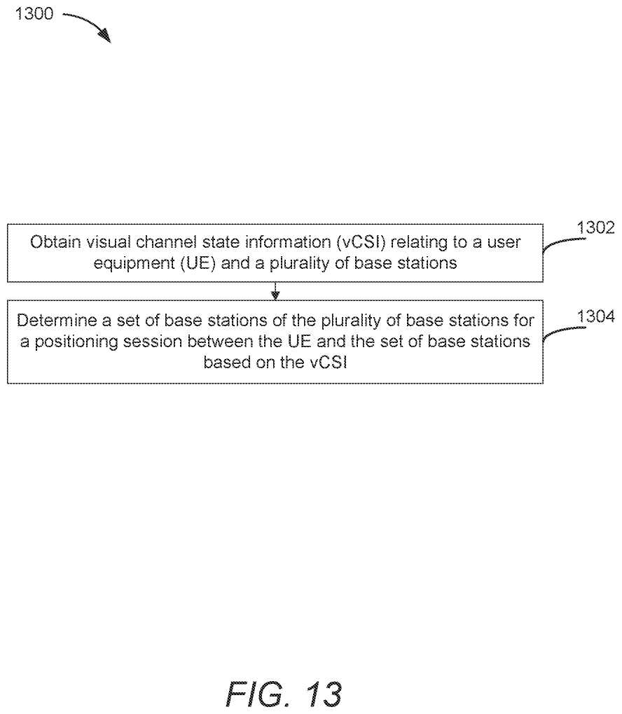

FIG. 13 illustrates an example method 1300 of wireless communication performed by a network node (e.g., UE, base station, location server, etc.), according to aspects of the disclosure. At operation 1302, the network node obtains vCSI relating to a UE and a plurality of base stations. In an aspect, operation 1302 may be performed by the one or more WWAN transceivers 310, the one or more processors 332, memory 340, and/or positioning component 342, any or all of which may be considered means for performing this operation. In an aspect, operation 1302 may be performed by the one or more WWAN transceivers 350, the one or more processors 384, memory 386, and/or positioning component 388, any or all of which may be considered means for performing this operation. In an aspect, operation 1302 may be performed by the one or more network transceivers 390, the one or more processors 394, memory 396, and/or positioning component 398, any or all of which may be considered means for performing this operation.

At operation 1304, the network node determines a set of base stations of the plurality of base stations for a positioning session between the UE and the set of base stations based on the vCSI. In an aspect, operation 1304 may be performed by the one or more WWAN transceivers 310, the one or more processors 332, memory 340, and/or positioning component 342, any or all of which may be considered means for performing this operation. In an aspect, operation 1304 may be performed by the one or more WWAN transceivers 350, the one or more processors 384, memory 386, and/or positioning component 388, any or all of which may be considered means for performing this operation. In an aspect, operation 1304 may be performed by the one or more network transceivers 390, the one or more processors 394, memory 396, and/or positioning component 398, any or all of which may be considered means for performing this operation.

As will be appreciated, a technical advantage of the method 1300 is that it enhances the accuracy of positioning a UE by selecting base stations for the positioning session based on visual information (e.g., vCSI) obtained for the positioning environment. In an aspect, the visual information may be used to identify LOS conditions between the UE and various base stations thereby allowing selection of base stations meeting desired LOS conditions for the positioning session. Additionally, or in the alternative, the visual information may be used to select base stations for positioning of the UE that optimize GDOP conditions. Additionally, or in the alternative, link quality may be gauged based on the vCSI. In an aspect, depth information from an image can translate to how close/far a TRP is with respect to the UE.

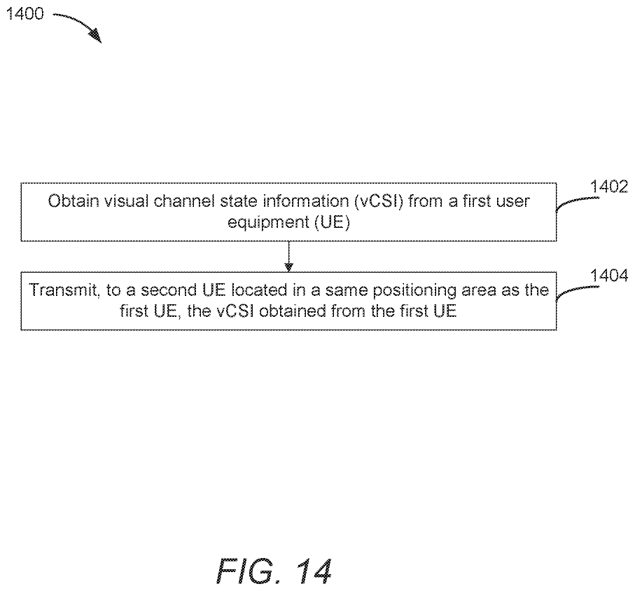

FIG. 14 illustrates an example method 1400 of wireless communication performed by a network node, according to aspects of the disclosure. At operation 1402, the network node obtains vCSI from a first UE. In an aspect, operation 1402 may be performed by the one or more WWAN transceivers 350, the one or more processors 384, memory 386, and/or positioning component 388, any or all of which may be considered means for performing this operation. In an aspect, operation 1402 may be performed by the one or more network transceivers 390, the one or more processors 394, memory 396, and/or positioning component 398, any or all of which may be considered means for performing this operation.

At operation 1404, the network node transmits, to a second UE located in a same positioning area as the first UE, the vCSI obtained from the first UE. In an aspect, operation 1404 may be performed by the one or more WWAN transceivers 350, the one or more processors 384, memory 386, and/or positioning component 388, any or all of which may be considered means for performing this operation. In an aspect, operation 1404 may be performed by the one or more network transceivers 390, the one or more processors 394, memory 396, and/or positioning component 398, any or all of which may be considered means for performing this operation.

As will be appreciated, a technical advantage of the method 1400 is that it allows a first UE in the same positioning area as a second UE to share vCSI obtained by the first UE. Such vCSI may even be shared with the second UE in scenarios in which the second UE does not have an imaging system to generate its own vCSI. Additionally, or in the alternative, the vCSI information can may be used to determine the conditions between UEs (e.g., SL-UEs). In an aspect, the UEs could use the vCSI to direct their beams towards one another. The search space for the beams may also be reduced based on the vCSI.

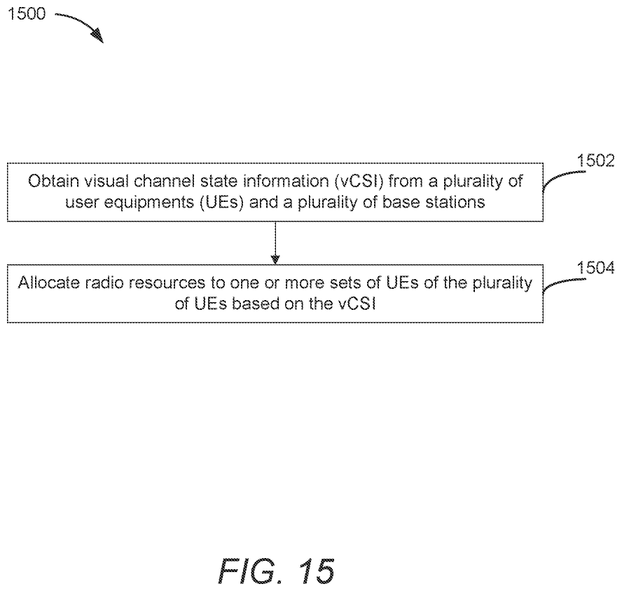

FIG. 15 illustrates an example method 1500 of wireless communication performed by a network node, according to aspects of the disclosure. At operation 1502, the network node obtains vCSI from a plurality of UEs and a plurality of base stations. In an aspect, operation 1502 may be performed by the one or more WWAN transceivers 310, the one or more processors 332, memory 340, and/or positioning component 342, any or all of which may be considered means for performing this operation. In an aspect, operation 1502 may be performed by the one or more WWAN transceivers 350, the one or more processors 384, memory 386, and/or positioning component 388, any or all of which may be considered means for performing this operation. In an aspect, operation 1502 may be performed by the one or more network transceivers 390, the one or more processors 394, memory 396, and/or positioning component 398, any or all of which may be considered means for performing this operation.

At operation 1504, the network node allocates radio resources to one or more sets of UEs of the plurality of UEs based on the vCSI. In an aspect, operation 1504 may be performed by the one or more WWAN transceivers 310, the one or more processors 332, memory 340, and/or positioning component 342, any or all of which may be considered means for performing this operation. In an aspect, operation 1504 may be performed by the one or more WWAN transceivers 350, the one or more processors 384, memory 386, and/or positioning component 388, any or all of which may be considered means for performing this operation. In an aspect, operation 1504 may be performed by the one or more network transceivers 390, the one or more processors 394, memory 396, and/or positioning component 398, any or all of which may be considered means for performing this operation.

As will be appreciated, a technical advantage of the method 1500 is that it allows the network node to obtain vCSI from multiple devices in the positioning environment and allocate communication resources to UEs within the positioning environment based on the vCSI. In an aspect, the vCSI may be used to create a visual map that may be used to map resources between base stations and UEs to efficiently use the available frequency and time resources.

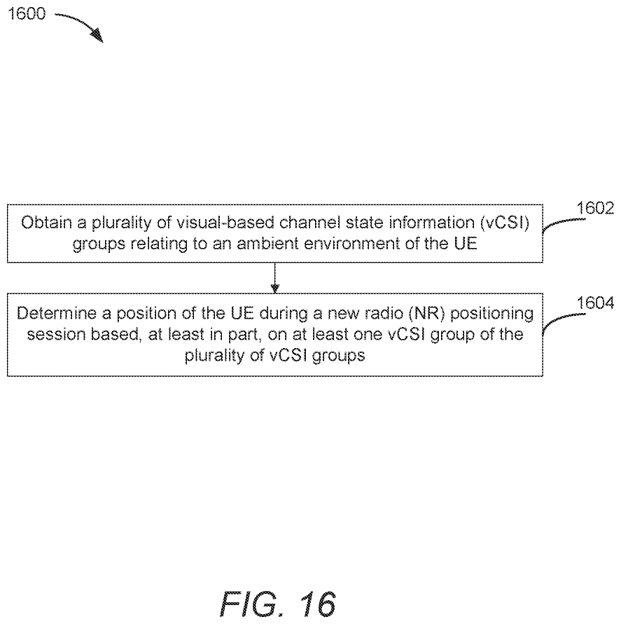

FIG. 16 shows an example method 1600 of wireless communication performed by a UE, according to aspects of the disclosure. At operation 1602, the UE obtains a plurality of visual-based channel state information (vCSI) groups relating to an ambient environment of the UE. In an aspect, operation 1602 may be performed by the one or more network transceivers 390, the one or more processors 394, memory 396, and/or positioning component 398, any or all of which may be considered means for performing this operation.

At operation 1604, the UE determines an estimated position of the UE during a new radio (NR) positioning session based, at least in part, on at least one vCSI group of the plurality of vCSI groups. In an aspect, operation 1604 may be performed by the one or more network transceivers 390, the one or more processors 394, memory 396, and/or positioning component 398, any or all of which may be considered means for performing this operation.

As will be appreciated, a technical advantage of the method 1600 is that it provides vCSI groups that may be used in an NR positioning session to obtain an estimated position of the UE. For example, the vCSI groups may be used to provide estimated angle measurements associated with the position of the UE that may be used to supplement, validate, or replace NR-based angle measurements.

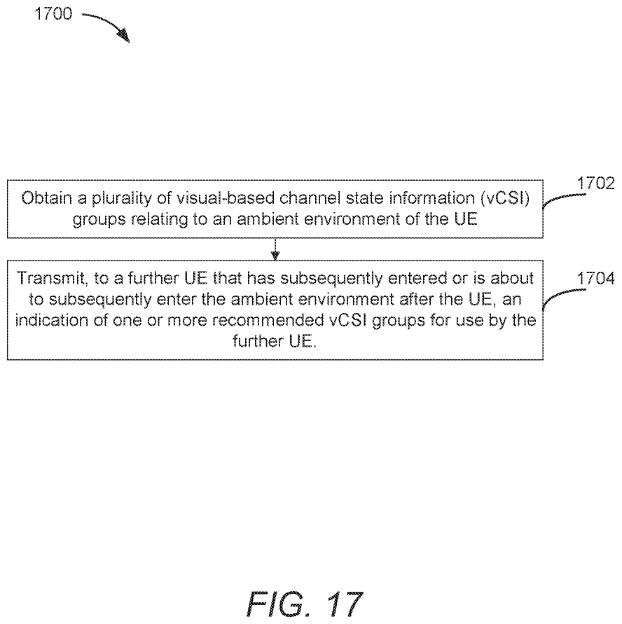

FIG. 17 shows an example method 1700 of wireless communication performed by a UE, according to aspects of the disclosure. At operation 1702, the UE obtains a plurality of vCSI groups relating to an ambient environment of the UE. In an aspect, operation 1702 may be performed by the one or more network transceivers 390, the one or more processors 394, memory 396, and/or positioning component 398, any or all of which may be considered means for performing this operation.

At operation 1704, the UE transmits, to a further UE that has subsequently entered or is about to subsequently enter the ambient environment after the UE, an indication of one or more recommended vCSI groups for use by the further UE. In an aspect, operation 1704 may be performed by the one or more network transceivers 390, the one or more processors 394, memory 396, and/or positioning component 398, any or all of which may be considered means for performing this operation.

As will be appreciated, a technical advantage of method 1700 is the leveraging of the UEs knowledge of the utility of various vCSI groups based on the UE's experience with the vCSI groups within the ambient environment. Such knowledge may be used to identify a set of recommended vCSI groups that may be useful to another UE that is entering or has recently entered the ambient environment.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: obtaining a plurality of visual-based channel state information (vCSI) groups relating to an ambient environment of the UE; and determining an estimated position of the UE during a new radio (NR) positioning session based, at least in part, on at least one vCSI group of the plurality of vCSI groups.

Clause 2. The method of clause 1, wherein: the plurality of vCSI groups are grouped according to types of visual features included in each vCSI group, a number of visual features included in each vCSI group, a positioning resolution obtainable using each vCSI group, or any combination thereof.

Clause 3. The method of any of clauses 1 to 2, wherein obtaining the vCSI groups comprises: receiving information indicating the plurality of vCSI groups from a network server.

Clause 4. The method of any of clauses 1 to 3, wherein obtaining the vCSI groups comprises: receiving a set of vCSI from a network server; and determining the plurality of vCSI groups based on the set of vCSI received from the network server.

Clause 5. The method of clause 4, further comprising: transmitting the plurality of vCSI groups to a network server; transmitting the plurality of vCSI groups to a sidelink UE; or any combination thereof.

Clause 6. The method of any of clauses 1 to 5, wherein obtaining the vCSI groups comprises: acquiring, at the UE, image data of the ambient environment of the UE; and generating the plurality of vCSI groups at the UE using the image data; and transmitting the plurality of vCSI groups to a network server.

Clause 7. The method of any of clauses 1 to 6, wherein determining the estimated position of the UE is based on: one or more range measurements based, at least in part, on measurements of reference signals (RS) transmitted between the UE and one or more transmission-reception points (TRPs); and one or more angle measurements based, at least in part, on one or more vCSI groups of the plurality of vCSI groups.

Clause 8. The method of clause 7, wherein: the one or more angle measurements are relative to an orientation of an image sensor associated with the UE with respect to the one or more vCSI groups of the plurality of vCSI groups.

Clause 9. The method of claim 7, wherein determining the estimated position of the UE includes: determining an angular resolution of the one or more angle measurements based on the one or more vCSI groups; determining an angular measurement uncertainty based on the one or more vCSI groups; or any combination thereof.

Clause 10. The method of any of clauses 1 to 9, wherein: one or more vCSI groups of the plurality of vCSI groups include an indication of an angular resolution of an orientation of the UE obtainable using each vCSI group.

Clause 11. The method of any of clauses 1 to 10, wherein determining the estimated position of the UE includes: at least partially combining two or more vCSI groups of the plurality of vCSI groups based on angular accuracy obtainable by at least partially combining the two or more vCSI groups.

Clause 12. The method of any of clauses 1 to 11, wherein: the plurality of vCSI groups are grouped based on a directionality of the UE with respect to one or more base stations.

Clause 13. The method of any of clauses 1 to 12, wherein: the plurality of vCSI groups are grouped based on orientations of antenna beams of one or more base stations with respect to the UE.

Clause 14. The method of any of clauses 1 to 13, wherein: the plurality of vCSI groups are grouped based on signal strengths of reference signals received by the UE from antenna beams of one or more base stations.

Clause 15. The method of any of clauses 1 to 14, wherein obtaining the plurality of vCSI groups comprises: receiving one or more vCSI groups of the plurality of vCSI groups in a system information block (SIB) transmission.

Clause 16. The method of any of clauses 1 to 15, wherein obtaining the plurality of vCSI groups comprises: receiving, in a system information block (SIB) transmission, an indication of a network location at which one or more vCSI groups of the plurality of vCSI groups can be retrieved by the UE.

Clause 17. The method of any of clauses 1 to 16, wherein: at least two or more vCSI groups of the plurality of vCSI groups are grouped based on visibilities of visual features included in the at least two or more vCSI groups under different ambient environmental conditions.

Clause 18. The method of clause 17, wherein: the different ambient environmental conditions include different weather conditions; different ambient lighting conditions; different times of day; or any combination thereof.

Clause 19. A method of wireless communication performed by a user equipment (UE), comprising: obtaining a plurality of visual-based channel state information (vCSI) groups relating to an ambient environment of the UE; and transmitting, to a further UE that has subsequently entered or is about to subsequently enter the ambient environment after the UE, an indication of one or more recommended vCSI groups for use by the further UE.

Clause 20. The method of clause 19, further comprising: determining the recommended vCSI groups based, at least in part, on visibility of visual features in one or more vCSI groups of the plurality of vCSI groups as determined at the UE, position measurements obtained by the UE based on the one or more vCSI groups, angular resolutions obtained by the UE based on the one or more vCSI groups, or any combination thereof.

Clause 21. A user equipment (UE), comprising: a memory; at least one transceiver; and at least one processor communicatively coupled to the memory and the at least one transceiver, the at least one processor configured to: obtain a plurality of visual-based channel state information (vCSI) groups relating to an ambient environment of the UE; and determine an estimated position of the UE during a new radio (NR) positioning session based, at least in part, on at least one vCSI group of the plurality of vCSI groups.

Clause 22. The UE of clause 21, wherein: the plurality of vCSI groups are grouped according to types of visual features included in each vCSI group, a number of visual features included in each vCSI group, a positioning resolution obtainable using each vCSI group, or any combination thereof.

Clause 23. The UE of any of clauses 21 to 22, wherein the at least one processor configured to obtain the vCSI groups comprises the at least one processor configured to: receive, via the at least one transceiver, information indicating the plurality of vCSI groups from a network server.

Clause 24. The UE of any of clauses 21 to 23, wherein the at least one processor configured to obtain the vCSI groups comprises the at least one processor configured to: receive, via the at least one transceiver, a set of vCSI from a network server; and determine the plurality of vCSI groups based on the set of vCSI received from the network server.

Clause 25. The UE of clause 24, wherein the at least one processor is further configured to: transmit, via the at least one transceiver, the plurality of vCSI groups to a network server; transmit, via the at least one transceiver, the plurality of vCSI groups to a sidelink UE; or any combination thereof.

Clause 26. The UE of any of clauses 21 to 25, wherein the at least one processor configured to obtain the vCSI groups comprises the at least one processor configured to: acquire, at the UE, image data of the ambient environment of the UE; and generate the plurality of vCSI groups at the UE using the image data; and transmit, via the at least one transceiver, the plurality of vCSI groups to a network server.

Clause 27. The UE of any of clauses 21 to 26, wherein determining the estimated position of the UE is based on: one or more range measurements based, at least in part, on measurements of reference signals (RS) transmitted between the UE and one or more transmission-reception points (TRPs); and one or more angle measurements based, at least in part, on one or more vCSI groups of the plurality of vCSI groups.

Clause 28. The UE of clause 27, wherein: the one or more angle measurements are relative to an orientation of an image sensor associated with the UE with respect to the one or more vCSI groups of the plurality of vCSI groups.

Clause 29. The UE of any of clauses 27 to 28, wherein determining the estimated position of the UE includes: determine an angular resolution of the one or more angle measurements based on the one or more vCSI groups; determine an angular measurement uncertainty based on the one or more vCSI groups; or any combination thereof.

Clause 30. The UE of any of clauses 21 to 29, wherein: one or more vCSI groups of the plurality of vCSI groups include an indication of an angular resolution of an orientation of the UE obtainable using each vCSI group.

Clause 31. The UE of any of clauses 21 to 30, wherein the at least one processor configured to determine the estimated position of the UE comprises the at least one processor configured to: at least partially combine two or more vCSI groups of the plurality of vCSI groups based on angular accuracy obtainable by at least partially combining the two or more vCSI groups.

Clause 32. The UE of any of clauses 21 to 31, wherein: the plurality of vCSI groups are grouped based on a directionality of the UE with respect to one or more base stations.

Clause 33. The UE of any of clauses 21 to 32, wherein: the plurality of vCSI groups are grouped based on orientations of antenna beams of one or more base stations with respect to the UE.

Clause 34. The UE of any of clauses 21 to 33, wherein: the plurality of vCSI groups are grouped based on signal strengths of reference signals received by the UE from antenna beams of one or more base stations.

Clause 35. The UE of any of clauses 21 to 34, wherein the at least one processor configured to obtain the plurality of vCSI groups comprises the at least one processor configured to: receive, via the at least one transceiver, one or more vCSI groups of the plurality of vCSI groups in a system information block (SIB) transmission.

Clause 36. The UE of any of clauses 21 to 35, wherein the at least one processor configured to obtain the plurality of vCSI groups comprises the at least one processor configured to: receive, via the at least one transceiver, in a system information block (SIB) transmission, an indication of a network location at which one or more vCSI groups of the plurality of vCSI groups can be retrieved by the UE.

Clause 37. The UE of any of clauses 21 to 36, wherein: at least two or more vCSI groups of the plurality of vCSI groups are grouped based on visibilities of visual features included in the at least two or more vCSI groups under different ambient environmental conditions.

Clause 38. The UE of clause 37, wherein: the different ambient environmental conditions include different weather conditions; different ambient lighting conditions; different times of day; or any combination thereof.

Clause 39. A user equipment (UE), comprising: a memory; at least one transceiver; and at least one processor communicatively coupled to the memory and the at least one transceiver, the at least one processor configured to: obtain a plurality of visual-based channel state information (vCSI) groups relating to an ambient environment of the UE; and transmit, via the at least one transceiver, to a further UE that has subsequently entered or is about to subsequently enter the ambient environment after the UE, an indication of one or more recommended vCSI groups for use by the further UE.

Clause 40. The UE of clause 39, wherein the at least one processor is further configured to: determine the recommended vCSI groups based, at least in part, on visibility of visual features in one or more vCSI groups of the plurality of vCSI groups as determined at the UE, position measurements obtained by the UE based on the one or more vCSI groups, angular resolutions obtained by the UE based on the one or more vCSI groups, or any combination thereof.

Clause 41. A user equipment (UE), comprising: means for obtaining a plurality of visual-based channel state information (vCSI) groups relating to an ambient environment of the UE: and means for determining an estimated position of the UE during a new radio (NR) positioning session based, at least in part, on at least one vCSI group of the plurality of vCSI groups.

Clause 42. The UE of clause 41, wherein: the plurality of vCSI groups are grouped according to types of visual features included in each vCSI group, a number of visual features included in each vCSI group, a positioning resolution obtainable using each vCSI group, or any combination thereof.

Clause 43. The UE of any of clauses 41 to 42, wherein the means for obtaining the vCSI groups comprises: means for receiving information indicating the plurality of vCSI groups from a network server.

Clause 44. The UE of any of clauses 41 to 43, wherein the means for obtaining the vCSI groups comprises: means for receiving a set of vCSI from a network server; and means for determining the plurality of vCSI groups based on the set of vCSI received from the network server.

Clause 45, The UE of clause 44, further comprising: means for transmitting the plurality of vCSI groups to a network server; means for transmitting the plurality of vCSI groups to a sidelink UE; or any combination thereof.

Clause 46. The UE of any of clauses 41 to 45, wherein the means for obtaining the vCSI groups comprises: means for acquiring, at the UE, image data of the ambient environment of the UE; and means for generating the plurality of vCSI groups at the UE using the image data; and means for transmitting the plurality of vCSI groups to a network server.

Clause 47. The UE of any of clauses 41 to 46, wherein determining the estimated position of the UE is based on: one or more range measurements based, at least in part, on measurements of reference signals (RS) transmitted between the UE and one or more transmission-reception points (TRPs); and one or more angle measurements based, at least in part, on one or more vCSI groups of the plurality of vCSI groups.

Clause 48. The UE of clause 47, wherein: the one or more angle measurements are relative to an orientation of an image sensor associated with the UE with respect to the one or more vCSI groups of the plurality of vCSI groups.

Clause 49. The UE of any of clauses 47 to 48, wherein determining the estimated position of the UE includes: means for determining an angular resolution of the one or more angle measurements based on the one or more vCSI groups; means for determining an angular measurement uncertainty based on the one or more vCSI groups; or any combination thereof.

Clause 50. The UE of any of clauses 41 to 49, wherein: one or more vCSI groups of the plurality of vCSI groups include an indication of an angular resolution of an orientation of the UE obtainable using each vCSI group.

Clause 51. The UE of any of clauses 41 to 50, wherein the means for determining the estimated position of the UE includes: means for at least partially combining two or more vCSI groups of the plurality of vCSI groups based on angular accuracy obtainable by at least partially combining the two or more vCSI groups.

Clause 52. The UE of any of clauses 41 to 51, wherein: the plurality of vCSI groups are grouped based on a directionality of the UE with respect to one or more base stations.

Clause 53. The UE of any of clauses 41 to 52, wherein: the plurality of vCSI groups are grouped based on orientations of antenna beams of one or more base stations with respect to the UE.

Clause 54. The UE of any of clauses 41 to 53, wherein: the plurality of vCSI groups are grouped based on signal strengths of reference signals received by the UE from antenna beams of one or more base stations.

Clause 55. The UE of any of clauses 41 to 54, wherein the means for obtaining the plurality of vCSI groups comprises: means for receiving one or more vCSI groups of the plurality of vCSI groups in a system information block (SIB) transmission.

Clause 56. The UE of any of clauses 41 to 55, wherein the means for obtaining the plurality of vCSI groups comprises: means for receiving, in a system information block (SIB) transmission, an indication of a network location at which one or more vCSI groups of the plurality of vCSI groups can be retrieved by the UE.

Clause 57. The UE of any of clauses 41 to 56, wherein: at least two or more vCSI groups of the plurality of vCSI groups are grouped based on visibilities of visual features included in the at least two or more vCSI groups under different ambient environmental conditions.

Clause 58. The UE of clause 57, wherein: the different ambient environmental conditions include different weather conditions; different ambient lighting conditions; different times of day; or any combination thereof.

Clause 59. A user equipment (UE), comprising: means for obtaining a plurality of visual-based channel state information (vCSI) groups relating to an ambient environment of the UE: and means for transmitting, to a further UE that has subsequently entered or is about to subsequently enter the ambient environment after the UE, an indication of one or more recommended vCSI groups for use by the further UE.

Clause 60. The UE of clause 59, further comprising: means for determining the recommended vCSI groups based, at least in part, on visibility of visual features in one or more vCSI groups of the plurality of vCSI groups as determined at the UE, positioning measurements obtained by the UE based on the one or more vCSI groups, angular resolutions obtained by the UE based on the one or more vCSI groups, or any combination thereof.

Clause 61. A non-transitory computer-readable medium storing computer-executable instructions that, when executed by a user equipment (UE), cause the UE to; obtain a plurality of visual-based channel state information (vCSI) groups relating to an ambient environment of the UE; and determine an estimated position of the UE during a new radio (NR) positioning session based, at least in part, on at least one vCSI group of the plurality of vCSI groups.

Clause 62. The non-transitory computer-readable medium of clause 61, wherein: the plurality of vCSI groups are grouped according to types of visual features included in each vCSI group, a number of visual features included in each vCSI group, a positioning resolution obtainable using each vCSI group, or any combination thereof.

Clause 63. The non-transitory computer-readable medium of any of clauses 61 to 62, wherein the computer-executable instructions that, when executed by the UE, cause the UE to obtain the vCSI groups comprise computer-executable instructions that, when executed by the UE, cause the UE to: receive information indicating the plurality of vCSI groups from a network server.

Clause 64. The non-transitory computer-readable medium of any of clauses 61 to 63, wherein the computer-executable instructions that, when executed by the UE, cause the UE to obtain the vCSI groups comprise computer-executable instructions that, when executed by the UE, cause the UE to: receive a set of vCSI from a network server; and determine the plurality of vCSI groups based on the set of vCSI received from the network server.

Clause 65. The non-transitory computer-readable medium of clause 64, further comprising computer-executable instructions that, when executed by the UE, cause the UE to: transmit the plurality of vCSI groups to a network server; transmit the plurality of vCSI groups to a sidelink UE; or any combination thereof.

Clause 66. The non-transitory computer-readable medium of any of clauses 61 to 65, wherein the computer-executable instructions that, when executed by the UE, cause the UE to obtain the vCSI groups comprise computer-executable instructions that, when executed by the UE, cause the UE to: acquire, at the UE, image data of the ambient environment of the UE; and generate the plurality of vCSI groups at the UE using the image data; and transmit the plurality of vCSI groups to a network server.

Clause 67. The non-transitory computer-readable medium of any of clauses 61 to 66, wherein determining the estimated position of the UE is based on: one or more range measurements based, at least in part, on measurements of reference signals (RS) transmitted between the UE and one or more transmission-reception points (TRPs); and one or more angle measurements based, at least in part, on one or more vCSI groups of the plurality of vCSI groups.

Clause 68. The non-transitory computer-readable medium of clause 67, wherein: the one or more angle measurements are relative to an orientation of an image sensor associated with the UE with respect to the one or more vCSI groups of the plurality of vCSI groups.

Clause 69. The non-transitory computer-readable medium of any of clauses 67 to 68, wherein determining the estimated position of the UE includes: determining an angular resolution of the one or more angle measurements based on the one or more vCSI groups; determining an angular measurement uncertainty based on the one or more vCSI groups; or any combination thereof.

Clause 70. The non-transitory computer-readable medium of any of clauses 61 to 69, wherein: one or more vCSI groups of the plurality of vCSI groups include an indication of an angular resolution of an orientation of the UE obtainable using each vCSI group.

Clause 71. The non-transitory computer-readable medium of any of clauses 61 to 70, wherein the computer-executable instructions that, when executed by the UE, cause the UE to determine the estimated position of the UE comprise computer-executable instructions that, when executed by the UE, cause the UE to: at least partially combine two or more vCSI groups of the plurality of vCSI groups based on angular accuracy obtainable by at least partially combining the two or more vCSI groups.

Clause 72. The non-transitory computer-readable medium of any of clauses 61 to 71, wherein: the plurality of vCSI groups are grouped based on a directionality of the UE with respect to one or more base stations.

Clause 73. The non-transitory computer-readable medium of any of clauses 61 to 72, wherein: the plurality of vCSI groups are grouped based on orientations of antenna beams of one or more base stations with respect to the UE.

Clause 74. The non-transitory computer-readable medium of any of clauses 61 to 73, wherein: the plurality of vCSI groups are grouped based on signal strengths of reference signals received by the UE from antenna beams of one or more base stations.

Clause 75. The non-transitory computer-readable medium of any of clauses 61 to 74, wherein the computer-executable instructions that, when executed by the UE, cause the UE to obtain the plurality of vCSI groups comprise computer-executable instructions that, when executed by the UE, cause the UE to: receive one or more vCSI groups of the plurality of vCSI groups in a system information block (SIB) transmission.

Clause 76. The non-transitory computer-readable medium of any of clauses 61 to 75, wherein the computer-executable instructions that, when executed by the UE, cause the UE to obtain the plurality of vCSI groups comprise computer-executable instructions that, when executed by the UE, cause the UE to: receive, in a system information block (SIB) transmission, an indication of a network location at which one or more vCSI groups of the plurality of vCSI groups can be retrieved by the UE.

Clause 77. The non-transitory computer-readable medium of any of clauses 61 to 76, wherein: at least two or more vCSI groups of the plurality of vCSI groups are grouped based on visibilities of visual features included in the at least two or more vCSI groups under different ambient environmental conditions.

Clause 78. The non-transitory computer-readable medium of clause 77, wherein; the different ambient environmental conditions include different weather conditions; different ambient lighting conditions; different times of day; or any combination thereof.

Clause 79. A non-transitory computer-readable medium storing computer-executable instructions that, when executed by a user equipment (UE), cause the UE to: obtain a plurality of visual-based channel state information (vCSI) groups relating to an ambient environment of the UE; and transmit, to a further UE that has subsequently entered or is about to subsequently enter the ambient environment after the UE, an indication of one or more recommended vCSI groups for use by the further UE.

Clause 80. The non-transitory computer-readable medium of clause 79, further comprising computer-executable instructions that, when executed by the UE, cause the UE to: determine the recommended vCSI groups based, at least in part, on visibility of visual features in one or more vCSI groups of the plurality of vCSI groups as determined at the UE, position measurements obtained by the UE based on the one or more vCSI groups, angular resolutions obtained by the UE based on the one or more vCSI groups, or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory,, read-only memory (ROM), erasable programmable ROM (EPROM), electrically erasable programmable ROM (EEPROM). registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a user equipment (UE), comprising:
obtaining a plurality of visual-based channel state information (vCSI) groups relating to an ambient environment of the UE; and
determining an estimated position of the UE during a new radio (NR) positioning session based, at least in part, on at least one vCSI group of the plurality of vCSI groups.

2. The method of claim 1, wherein:
the plurality of vCSI groups are grouped according to types of visual features included in each vCSI group,
a number of visual features included in each vCSI group, a positioning resolution obtainable using each vCSI group, or any combination thereof.

3. The method of claim 1, wherein obtaining the vCSI groups comprises:
receiving information indicating the plurality of vCSI groups from a network server.

4. The method of claim 1, wherein obtaining the vCSI groups comprises:
receiving a set of vCSI from a network server, and
determining the plurality of vCSI groups based on the set of vCSI received from the network server.

5. (canceled)

6. The method of claim 1, wherein obtaining the vCSI groups comprises:
acquiring, at the UE, image data of the ambient environment of the UE; and generating the plurality of vCSI groups at the UE using the image data; and
transmitting the plurality of vCSI groups to a network server.

7. The method of claim 1, wherein determining the estimated position of the UE is based on:
one or more range measurements based, at least in part, on measurements of reference signals (RS) transmitted between the UE and one or more transmission-reception points (TRPs); and
one or more angle measurements based, at least in part, on one or more vCSI groups of the plurality of vCSI groups.

8. (canceled)

9. (canceled)

10. The method of claim 1, wherein:
one or more vCSI groups of the plurality of vCSI groups include an indication of an angular resolution of an orientation of the UE obtainable using each vCSI group.

11. (canceled)

12. (canceled)

13. (canceled)

14. (canceled)

15. The method of claim 1, wherein obtaining the plurality of vCSI groups comprises:
receiving one or more vCSI groups of the plurality of vCSI groups in a system information block (SIB) transmission.

16. The method of claim 1, wherein obtaining the plurality of vCSI groups comprises:
receiving, in a system information block (SIB) transmission, an indication of a network location at which one or more vCSI groups of the plurality of vCSI groups can be retrieved by the UE.

17. The method of claim 1, wherein;
at least two or more vCSI groups of the plurality of vCSI groups are grouped based on visibilities of visual features included in the at least two or more vCSI groups under different ambient environmental conditions.

18. The method of claim 17, wherein:
the different ambient conditions include different weather conditions;
different ambient lighting conditions;
different times of day; or any combination thereof.

19. (canceled)

20. (canceled)

21. A user equipment (UE), comprising:
a memory;
at least one transceiver; and
at least one processor communicatively coupled to the memory and the at least one transceiver, the at least one processor configured to:
obtain a plurality of visual-based channel state information (vCSI) groups relating to an ambient environment of the UE; and
determine an estimated position of the UE during a new radio (NR) positioning session based, at least in part, on at least one vCSI group of the plurality of vCSI groups.

22. The UE of claim 21, wherein:
the plurality of vCSI groups are grouped according to types of visual features included in each vCSI group,
a number of visual features included in each vCSI group, a positioning resolution obtainable using each vCSI group, or
any combination thereof.

23. The UE of claim 21, wherein the at least one processor configured to obtain the vCSI groups comprises the at least one processor configured to:
receive, via the at least one transceiver, information indicating the plurality of vCSI groups from a network server.

24. The UE of claim 21, wherein the at least one processor configured to obtain the vCSI groups comprises the at least one processor configured to:
receive, via the at least one transceiver, a set of vCSI from a network server; and determine the plurality of vCSI groups based on the set of vCSI received from the network server.

25. The UE of claim 24, wherein the at least one processor is further configured to:
transmit, via the at least one transceiver, the plurality of vCSI groups to a network server;
transmit, via the at least one transceiver, the plurality of vCSI groups to a sidelink UE; or any combination thereof.

26. The UE of claim 21, wherein the at least one processor configured to obtain the vCSI groups comprises the at least one processor configured to:
acquire, at the UE, image data of the ambient environment of the UE; and
generate the plurality of vCSI groups at the UE using the image data; and
transmit, via the at least one transceiver, the plurality of vCSI groups to a network server.

27. The UE of claim 21, wherein determining the estimated position of the UE is based on:
one or more range measurements based, at least in part, on measurements of reference signals (RS) transmitted between the UE and one or more transmission-reception points (TRPs); and
one or more angle measurements based, at least in part, on one or more vCSI groups of the plurality of vCSI groups.

28. The UE of claim 21, wherein the at least one processor configured to obtain the plurality of vCSI groups comprises the at least one processor configured to:
receive, via the at least one transceiver, in a system information block (SIB) transmission, an indication of a network location at which one or more vCSI groups of the plurality of vCSI groups can be retrieved by the UE.

29. A user equipment (UE), comprising:
a memory;
at least one transceiver; and
at least one processor communicatively coupled to the memory and the at least one transceiver, the at least one processor configured to:
obtain a plurality of visual-based channel state information (vCSI) groups relating to an ambient environment of the UE; and
transmit, via the at least one transceiver, to a further UE that has subsequently entered or is about to subsequently enter the ambient environment after the UE, an indication of one or more recommended vCSI groups for use by the further UE.

30. (canceled)
